(19) United States
(12) Patent Application Publication
(10) Pub. No.: US 2015/0348382 A1
(43) Pub. Date: Dec. 3, 2015

(54) MONITOR INFORMATION PROCESSING DEVICE AND METHOD, AND PROGRAM AND RECORDING MEDIUM

(71) Applicant: MITSUBISHI ELECTRIC CORPORATION, Chiyoda-ku, Tokyo (JP)

(72) Inventors: Satoshi MICHIHATA, Tokyo (JP); Kiyoyasu MARUYAMA, Tokyo (JP)

(73) Assignee: MITSUBISHI ELECTRIC CORPORATION, Tokyo (JP)

(21) Appl. No.: 14/655,596

(22) PCT Filed: Nov. 20, 2013
(86) PCT No.: PCT/JP2013/081271

§ 371 Date: Jun. 25, 2015

(30) Foreign Application Priority Data
Mar. 5, 2013 (JP) 2013-042718

(51) Int. Cl. G08B 13/196; G07C 9/00

(52) U.S. Cl. CPC G08B 13/19613; G08B 13/19608; G07C 9/00007

(57) ABSTRACT

Illicit movement is detected on the basis of authentication result information (D3), door open/close information (D4), and changes in the quantity of encoded data (D2) of a video image of the vicinity of a door (9). An illicit movement is found to have occurred when the length of an interval during which the data quantity (D5) for each period is continuously greater than a threshold, or an integral (D80) of the data quantity (D5) exceeds a threshold, while the door is in an unlocked state. It is thereby possible to detect illicit entry into a controlled area with high precision, without decoding the encoded video data from the monitoring camera, and without carrying out complex image processing.

### TECHNICAL FIELD

The present invention relates to a monitor information processing device and method for monitoring the movement of people from one of a controlled area and a public area to the other. The invention also relates to a program for causing a computer to execute the monitor information processing method, and a computer-readable recording medium in which the program is recorded.

### BACKGROUND ART

Among monitoring devices that monitor the entry to or exit from a controlled area such as a place where secret information or hazardous substances are handled, recently there have been monitoring devices configured to authenticate entry authorization by verification of an ID card or the like at the time of entry or exit, and the door is unlocked only when entry authorization is confirmed. There are, however, cases (referred to below as ‘tailgating’) in which a person without entry authorization enters or exits the controlled area by following a person whose entry authorization has been authenticated.

To solve this problem, an entrance/exit monitoring device that detects tailgating by processing video images obtained by imaging with two cameras is disclosed in a patent reference 1. In the image processing in this entrance/exit monitoring system, difference images showing the difference between baseband signals obtained by A/D conversion of analog video signals input from the cameras and background images prestored in a memory are generated; the generated difference images are binarized by use of a predetermined threshold; areas preset by the operator are extracted from the binarized image data; vertical and horizontal projections are calculated from the extracted image data; the vertically and horizontally projected data are then smoothed, and tailgating detection is carried out on the basis of the data thus obtained.

### PRIOR ART REFERENCE

### Patent Reference

Patent reference 1: Japanese Patent Application Publication No. 2007-122481 (0028-0033)

### SUMMARY OF THE INVENTION

### Problems to be Solved by the Invention

Problems associated with the entrance/exit monitoring device described in the patent reference 1 are that it requires a memory for storing the background images, and it requires processing to generate the difference images from the baseband signals, binarize the images with a threshold, calculate projections, and so on, so that the amount of data processing is large. In particular, with advances in camera resolution, the data quantity of the baseband signals increases, so that the amount of processing involved in the image processing of the baseband signals is increased considerably. If this image processing is implemented in software, a CPU with a high operating frequency is needed, leading to an increase in cost. If the image processing is implemented in hardware, special-purpose LSI circuit chips are required, and the number of parts are increased, leading to an increase in cost.

Moreover, with the entrance/exit monitoring device described in the patent reference 1, image processing of the baseband signals is necessary, so that if cameras of the currently common type that output the captured image in encoded form are connected, decoding is necessary in order to restore baseband signals from the video data from the cameras. Much additional signal processing is therefore needed for the decoding process, requiring a higher performance CPU or an increased number of parts, leading to a cost increase.

A purpose of the present invention is to enable detection of illicit entry or exit without decoding encoded video data from a camera to a baseband signal, and without performing complex image processing and the like.

### Means for Solving the Problem

A monitor information processing device according to one aspect invention is a monitor information processing device that detects illicit movement from one of a public area and a controlled area separated by a door to the other, on a basis of

authentication result information indicating permission of movement from one of the public area and the controlled area to the other, generated as a result of a decision as to whether or not to permit the movement, the decision being based on identification information presented by the person attempting the movement,

door open/close information indicating a state of the door, the opening and closing of which are controlled on a basis of the authentication result information, and

encoded video data generated by encoding a video signal obtained by imaging a vicinity of the door,

the monitor information processing device comprising:

a data quantity measurement unit for measuring a data quantity, for each predetermined period, of the encoded video data; and

a comparison/determination unit for detecting the illicit movement on a basis of the door open/close information, the authentication result information, and a length of an interval during which the data quantity for each predetermined period measured by the data quantity measurement unit is continuously greater than a predetermined data quantity threshold.

A monitor information processing device according to another aspect invention is a monitor information processing device that detects illicit movement from one of a public area and a controlled area separated by a door to the other, on a basis of

authentication result information indicating permission of movement from one of the public area and the controlled area to the other, generated as a result of a decision as to whether or not to permit the movement, the decision being based on identification information presented by the person attempting the movement,

door open/close information indicating a state of the door, the opening and closing of which are controlled on a basis of the authentication result information, and

encoded video data generated by encoding a video signal obtained by imaging a vicinity of the door,

the monitor information processing device comprising:

a data quantity measurement unit for measuring a data quantity, for each predetermined period, of the encoded video data; and

a comparison/determination unit for detecting the illicit movement on a basis of the door open/close information, the authentication result information, and an integral of the data quantity in an interval during which the data quantity for each predetermined period measured by the data quantity measurement unit is continuously greater than a predetermined data quantity threshold.

### Effects of the Invention

According to the present invention, illicit entry or exit can be detected without decoding encoded video data from a camera to a baseband signal, and without performing complex image processing and the like.

### BRIEF DESCRIPTION OF THE DRAWINGS

FIG. 1 is a block diagram showing a monitor information processing device in a first embodiment of the invention.

FIG. 2 is a plan view showing an example of the arrangement of the monitoring device (100) in the vicinity of a door (9) separating a controlled area (CA) from a public area (PA).

FIG. 3 is a block diagram showing an example of the configuration of the data quantity measurement unit (5) in FIG. 1.

FIG. 4 is a diagram illustrating the data structure of an IP packet.

FIG. 5 is a block diagram showing an example of the configuration of the comparison/determination unit (6) in FIG. 1.

FIGS. 6(a) to 6(h) show an exemplary sequence of consecutive image frames taken by the camera (2).

FIG. 7(a) is a waveform diagram showing changes in the data quantity from entry of a single person into the camera's field of view until the person leaves the field of view; FIG. 7(b) shows the data quantity for each accumulation period in FIG. 7(a).

FIG. 8(a) is a waveform diagram showing changes in the data quantity from entry of two people into the camera's field of view until they leave the field of view; FIG. 8(b) shows the data quantity for each accumulation period in FIG. 8(a).

FIG. 9 is a flowchart illustrating the operation of the monitor information processing device in the first embodiment.

FIG. 10 is a flowchart illustrating details of the data quantity measurement process in step S5 in FIG. 9.

FIG. 11 is a flowchart illustrating details of the comparison/determination process in steps S6 and S7 in FIG. 9.

FIG. 12 is a plan view showing a different example of the arrangement of the monitoring device (200) in the vicinity of the door (9) separating the controlled area (CA) from the public area (PA).

FIG. 13 is a plan view showing a different example of the arrangement of the components of the monitoring device (100) in the vicinity of the door (9) separating the controlled area (CA) from the public area (PA).

FIG. 14 is a block diagram showing a monitor information processing device in a fourth embodiment of the invention.

FIG. 15 is a block diagram showing an example of the configuration of the data quantity measurement unit (305) in FIG. 14.

FIG. 16 is a block diagram showing an example of the configuration of the comparison/determination unit (306) in FIG. 14.

FIG. 17 is a block diagram showing an example of the configuration of the comparison/determination unit (406) in a fifth embodiment of the invention.

FIGS. 18(a) to 18(h) show a different exemplary sequence of consecutive image frames taken by the camera (2).

FIG. 19(a) is a waveform diagram showing changes in the data quantity when two people transit the camera's field of view with no gap between them; FIG. 19(b) shows the data quantity for each accumulation period in FIG. 19(a).

FIG. 20 is a flowchart illustrating details of the comparison/determination process in steps S6 and S7 in FIG. 9 in the fifth embodiment.

FIG. 21 is a block diagram showing an example of the configuration of the comparison/determination unit (506) in a sixth embodiment of the invention.

FIG. 22(a) is a waveform diagram showing changes in the data quantity when two people transit the camera's field of view with no gap between them; FIG. 22(b) shows the data quantity for each accumulation period in FIG. 22(a).

### MODE FOR CARRYING OUT THE INVENTION

### First Embodiment

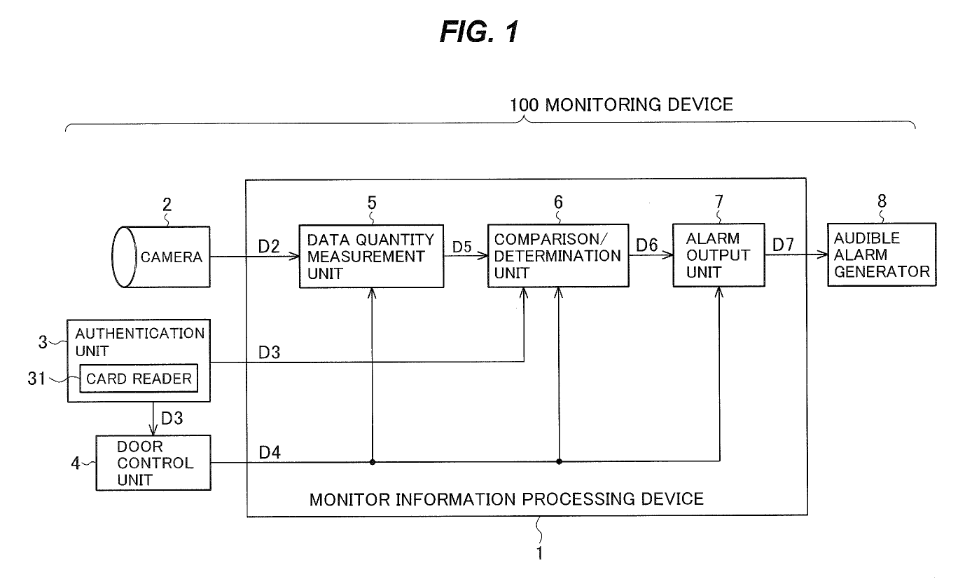

FIG. 1 is a block diagram showing the configuration of a monitor information processing device 1 in a first embodiment of the invention and component elements connected to the monitor information processing device 1.

The monitor information processing device 1 shown in FIG. 1 includes a data quantity measurement unit 5, a comparison/determination unit 6, and an alarm output unit 7 and is connected to a camera 2 used as an imaging signal generation unit, an authentication unit 3, a door control unit 4, and an audible alarm generator 8. The monitor information processing device 1, the camera 2, the authentication unit 3, the door control unit 4, and the audible alarm generator 8 in FIG. 1 constitute a monitoring device 100.

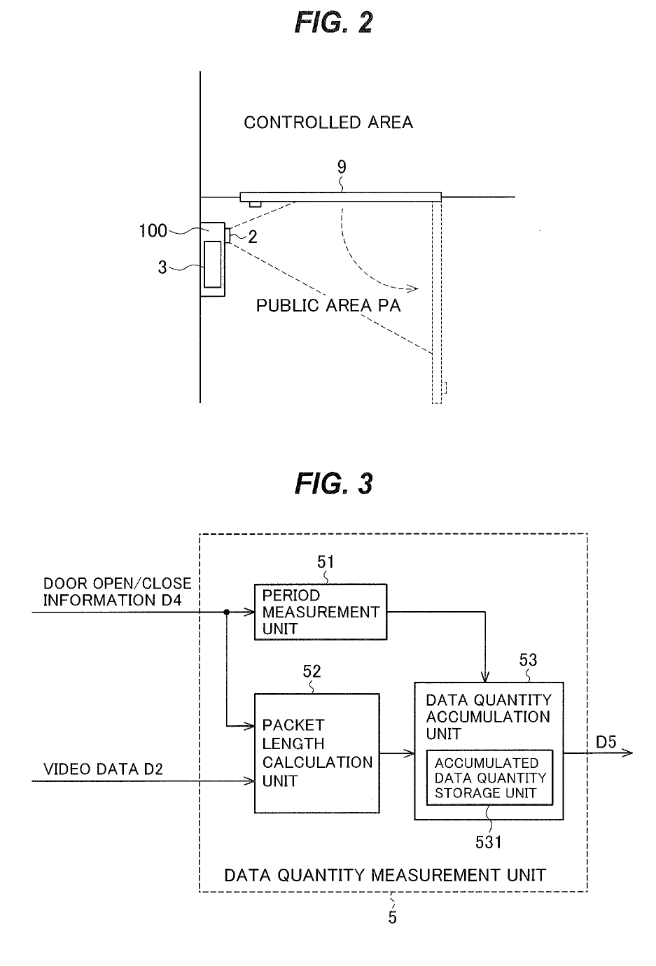

FIG. 2 shows an example of the arrangement of the monitoring device 100. FIG. 2 is a top view of the vicinity of a door 9 that separates a public area PA from a controlled area CA.

When a person enters (makes entry into) the controlled area CA from the public area PA, it is necessary to receive authentication. The monitoring device 100 is intended to detect illicit entry performed without receiving authentication.

Authentication for entry is performed, for example, when an IC card is placed over the authentication unit 3.

The camera 2 is installed such that a person who enters or exits through the opened door 9 can be imaged. The camera 2 is installed, for example, very close to the authentication unit 3 and at a height such that it can image the face of a person who approaches to place an IC card over the authentication unit 3.

The camera 2 and the monitor information processing device 1 are connected through a network line, for example, through a LAN (Local Area Network). The description below will assume the network to be an IP network. The network, however, is not limited to an IP network; what is required is that it provides a means for transmitting video images and information. Communication may be either wired or wireless (a wireless LAN, or the like).

The camera 2 transmits video data D2 generated by compressing, e.g., by H.264 encoding, the video signal obtained by imaging, to the monitor information processing device 1 via the network line.

The encoding system is not limited to H.264; it may be any encoding system, such as MPEG-2 or MPEG-4, that uses motion compensation and interframe prediction.

The authentication unit 3 includes, for example, a card reader 3a; when a person attempting entry places an IC card over (brings the IC card near) the card reader 3a, it reads identification information in the IC card and determines whether or not to permit entry on the basis of the information thus read. A list of the identification information of people authorized to enter (people whose entry is permitted), for example, is prestored in the authentication unit 3, and if the identification information read from an IC card matches any of the identification information included in the list of identification information, the authentication unit 3 grants permission for the entry of the person holding the IC card.

When entry is permitted, authentication result information D3 indicating permission is sent to the door control unit 4 and the monitor information processing device 1. When entry is not permitted, authentication result information D3 indicating denial of permission is sent to the door control unit 4 and the monitor information processing device 1.

Instead of personal authentication by IC cards, biometric authentication by fingerprints or the like may be used. To summarize, the authentication unit 3 may be any unit that accepts individual identification information presented by a person attempting entry into the controlled area CA and determines whether or not to permit the entry on the basis of the individual identification information that has been presented.

The door control unit 4 has functions of controlling the locking and unlocking of the door according to a notification from the authentication unit 3 and notifying the monitor information processing device 1 of whether the door is in the unlocked state or in the locked state.

In order to implement the above functions, the door control unit 4 has a function of communicating with the authentication unit 3, and is configured to be capable of receiving the authentication result information D3 from the authentication unit 3.

The communication protocol between the door control unit 4 and the authentication unit 3 may be a generally known serial communication protocol, such as the IIC (Inter-Integrated Circuit) protocol. Communication is not limited to serial communication; it may be any communication enabling data to be sent and received.

In the control of the locking and unlocking of the door by the door control unit 4, the door is unlocked when the authentication result information D3 from the authentication unit 3 indicates entry permission, and the door is locked after the lapse of a predetermined interval from unlocking. When the authentication result information D3 from the authentication unit 3 indicates entry denial (entry prohibition), the door is not unlocked. If the door is of the type that opens and closes automatically, the unlocking operation causes the door to open, and after the lapse of a certain interval, the door closes and becomes locked.

The door control unit 4 also outputs, to the monitor information processing device 1, door open/close information D4 indicating whether the door is in the unlocked state or the locked state. In order to implement the above function, the door control unit 4 and the monitor information processing device 1 communicate with each other by a generally known serial communication protocol, such as IIC. The communication system is not limited to serial communication; it may be any communication that enable data to be sent and received. The door open/close information D4 represents the unlocked state of the door 9 by ‘1’ and the locked state of the door 9 by ‘0’.

The audible alarm generator 8 includes a speaker, for example, and generates an audible alarm on reception of an alarm driving signal D7 from the monitor information processing device 1.

The data quantity measurement unit 5 measures the data quantity of the encoded video data D2 input from the camera 2 while the door 9 is held unlocked by the door control unit 4. Specifically, it has functions of subtracting the data size of the packet header portion of an IP packet of the video data D2 input from the camera 2, from the data size of the entire IP packet, recorded in the packet header, thereby calculating the data quantity of the video data included in the packet, and sending the result of accumulation of the calculated data quantity over a prescribed time period, as an accumulated data quantity D5, to the comparison/determination unit 6.

The data quantity measurement unit 5 includes, for example, a period measurement unit 51, a packet length calculation unit 52, and a data quantity accumulation unit 53, as shown in FIG. 3.

When the door open/close information D4 input from the door control unit 4 is ‘1’, that is, when the door 9 is held unlocked, the period measurement unit 51 starts measurement of a prescribed unit time (period). When the door open/close information D4 is ‘0’, that is, when the door 9 is locked, it stops the measurement of the prescribed unit time and resets itself. The unit time is measured by using a timer generated from the clock used by the monitor information processing device 1.

The door open/close information D4 is also input to the packet length calculation unit 52. From the header portion of an IP packet of the encoded video data D2 input from the camera 2 when the door open/close information D4 is ‘1’, the packet length calculation unit 52 extracts information indicating the data size of the entire IP packet and information indicating the data size of the header; then the packet length calculation unit 52 calculates a value obtained by subtracting the data size of the header from the data size of the entire IP packet, and outputs the result as a value indicating the data quantity of the video data included in the IP packet, to the data amount accumulation unit 53.

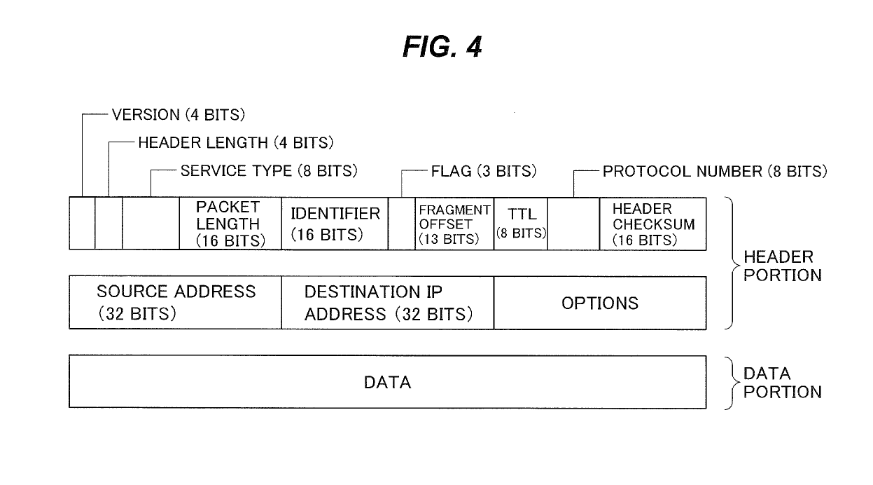

The operation of the packet length calculation unit 52 will now be described in further detail with reference to FIG. 4.

FIG. 4 is a diagram showing the structure of an IP packet. An IP packet consists of a header portion (20 bytes plus a number of bytes for options) including the IP address of the destination and other information, and a data portion including the payload data (the video data, which are the data to be transmitted).

The ‘header length’ stored in the header portion in FIG. 4 represents the data length of the header portion. The ‘packet length’ represents the data length of the entire IP packet, including the header portion. Accordingly, the data length of the data portion can be determined by subtracting the value of the header length from the value of the packet length. In the illustrated example, the packet length and the header length are represented by numeric values in units of octets (8 bits).

The packet length calculation unit 52 extracts the information representing the header length and the information representing the packet length stored in the header portion of the received IP packet, and subtracts the value of the header length from the value of the packet length to calculate the data quantity of the video data included in the received IP packet.

The data quantity accumulation unit 53 accumulates, in an internal accumulated data quantity storage unit 531, the data quantities of the video data in the individual packets, input from the packet length calculation unit 52, over a predetermined unit time measured by the period measurement unit 51, and outputs the accumulated data quantity for each unit time. The unit time over which the data quantity is accumulated will also be referred to as the accumulation period, or simply as the period.

The accumulated data quantity determined by the data quantity accumulation unit 53 is output, as the accumulated data quantity D5 for each period, from the data quantity measurement unit 5 to the comparison/determination unit 6. The accumulated data quantity D5 will also be referred to below as the ‘data quantity for each period’, or simply as the ‘data quantity’.

After outputting the accumulated data quantity D5, the data quantity accumulation unit 53 resets to zero the accumulated data quantity stored in the accumulated data quantity storage unit 531 and starts accumulation over the next period.

The comparison/determination unit 6 determines whether illicit entry has occurred on the basis of the accumulated data quantity D5 that was input from the data quantity measurement unit 5 and the number of times D32 that the authentication result information D3 indicating entry permission was output by the authentication unit 3 while the door 9 was indicated to be in the unlocked state by the door open/close information D4 from the door control unit 4, and reports the result of its determination to the alarm output unit 7.

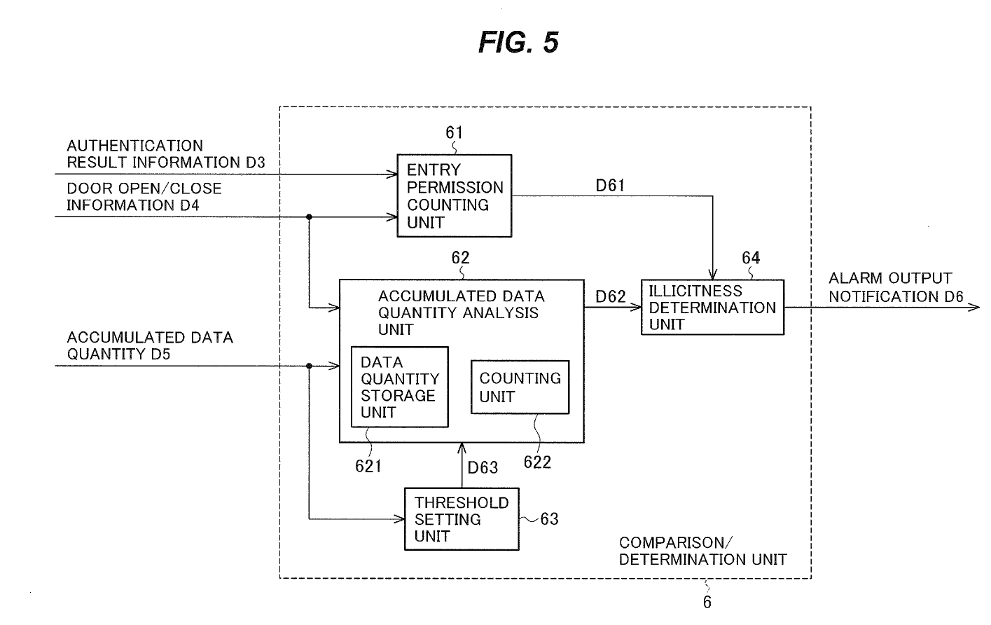

The comparison/determination unit 6 includes, for example, an entry permission counting unit 61, an accumulated data quantity analysis unit 62, a threshold setting unit 63, and an illicitness determination unit 64 as shown in FIG. 5.

The entry permission counting unit 61 measures the number of times that the authentication unit 3 has decided to grant entry permission, on the basis of the authentication result information D3 input from the authentication unit 3.

The entry permission that caused the door open/close information D4 to become ‘1’ (the entry permission granted just before the door open/close information D4 changes from ‘0’ to ‘1’) must also be included in this count. Therefore, the entry permission counting unit 61 sets the count value to ‘1’ when the door open/close information D4 becomes ‘1’, and subsequently increments the count value by ‘1’ whenever it receives the authentication result information indicating entry permission from the authentication unit 3. By such processing, the entry permission counting unit 61 counts the entry permission that causes the door open/close information D4 to become ‘1’ and the number of occurrences of entry permission granted while the door open/close information D4 is ‘1’. A count value D61 obtained by the entry permission counting unit 61 is equal to a value obtained by adding 1 to the number of occurrences of the authentication result information D3 indicating entry permission during the time when the door open/close information D4 is ‘1’.

When the door open/close information D4 changes from ‘1’ to ‘0’, the entry permission counting unit 61 outputs the count value D61 to the illicitness determination unit 64 and then resets the internally stored count value D61 to 0.

The threshold setting unit 63 sets a threshold (data quantity threshold) D63 used for analysis of the accumulated data quantity in the accumulated data quantity analysis unit 62.

The accumulated data quantity analysis unit 62 analyzes the data quantity D5 for each period as measured by the data quantity measurement unit 5. The accumulated data quantity analysis unit 62 includes, for example, a data quantity storage unit 621 for storing the data quantity D5 for each period input from the data quantity measurement unit 5, and stores, in the data quantity storage 621, the data quantity D5(n) for the most recent accumulation period and the data quantity D5(n−1) for the immediately preceding accumulation period.

The accumulated data quantity analysis unit 62 uses the threshold D63 input from the threshold setting unit 63 to determine whether the data quantity D5 has changed in the increasing direction across the threshold D63 while the door open/close information D4 remains ‘1’. Specifically, it determines whether the data quantity D5(n) for the most recent accumulation period and the data quantity D5(n−1) for the immediately preceding accumulation period satisfy the decision condition represented by the following expression (1).

D5(n)>D63>D5(n−1) (1)

The accumulated data quantity analysis unit 62 includes a counting unit 622 that counts the number of times that the above expression (1) is satisfied; the count value in the counting unit 622 is incremented by 1 whenever the above expression (1) is satisfied.

When the door open/close information D4 becomes ‘0’, the accumulated data quantity analysis unit 62 outputs the count value D62 to the illicitness determination unit 64.

After outputting the count value D62, the accumulated data quantity analysis unit 62 resets the count value D62 stored in the counting unit 622 to 0.

From the count value D61 furnished by the entry permission counting unit 61 and the count value D62 furnished as an analysis result by the accumulated data quantity analysis unit 62, the illicitness determination unit 64 determines whether illicit entry has occurred. Specifically, the illicitness determination unit 64 compares the count value D61 from the entry permission counting unit 61 and the count value D62 from the counting unit 622 in the accumulated data quantity analysis unit 62. If they do not match, it determines that illicit entry, i.e., tailgating has occurred, and sets an alarm output notification D6 to ‘1’. If they match, it sets the alarm output notification D6 to ‘0’. The alarm output notification D6 is output to the alarm output unit 7.

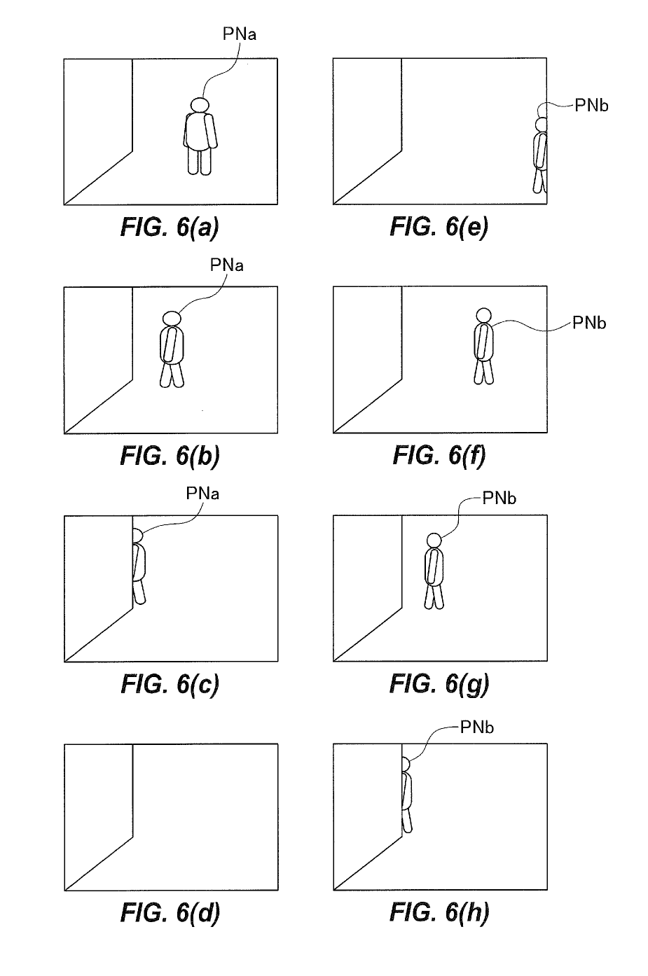

The significance of determining whether a person has passed through, from the data quantity for each period will now be explained. FIGS. 6(a) to 6(h) show images of frames captured by the camera 2 at different points in time. The frame rate is about 10 fps to 30 fps, for example; the images shown in FIGS. 6(b) to 6(h) respectively follow the images in FIGS. 6(a) to 6(g) by several frames.

In the illustrated scenario, a person PNa positioned substantially in front of the camera as shown in FIG. 6(a) moves, as shown in and after FIG. 6(b), transiting the opened door 9 into the controlled area CA, and another person PNb subsequently appears from the right, moves in front of the camera, and enters the controlled area CA.

The camera 2 encodes these captured images. In encoding systems such as H.264, predictive encoding is performed by using the current frame and the frames preceding and following it. Therefore, when appearance, movement, or the like of a subject occurs, the interframe differences increase, and hence the quantity of encoded data increases.

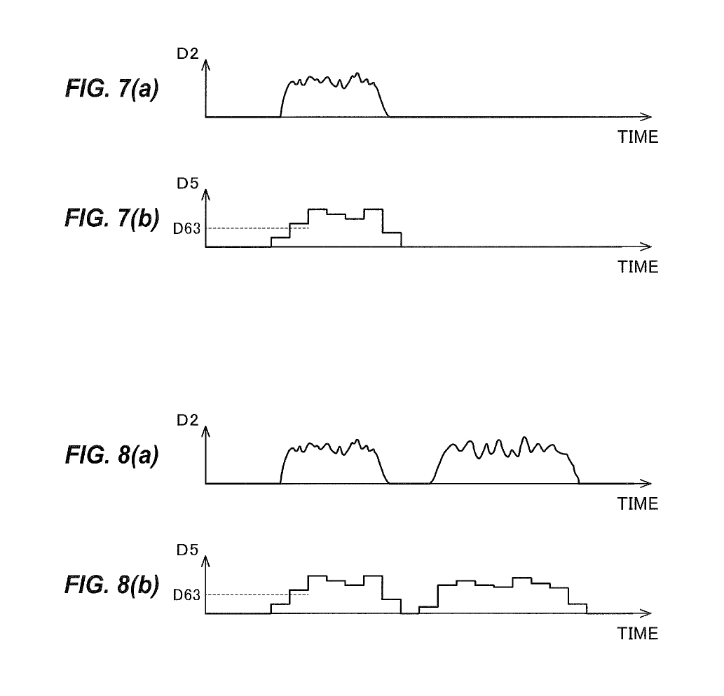

FIG. 7(a) shows exemplary changes in the data quantity when a person enters the field of view of the camera, moves through the field of view, and then leaves. As shown, until the person appears, the data quantity is substantially zero; the quantity is large when the person appears, moves, and disappears from view; it returns to zero after the person disappears from view. That is, broadly speaking, the data quantity increases from zero and then decreases back to zero, so that the changes are generally hill-shaped. The changes in the data quantity when imaging starts from a state in which a person is originally in the field of view of the camera, then moves and disappears from view are similarly hill-shaped.

FIG. 8(a) shows an example of the changes in the data quantity when two people enter the field of view in succession, move through the field of view, and then leave. In this case, the data quantity increases from zero, thereafter decreases to zero, and then increases and decreases again. That is, the changes in the data quantity form two repeated hills. The invention takes notice of such differences in the changes in the data quantity to detect tailgating.

Specifically, the number of times that a person has transited the field of view of the camera is counted, thereby counting the number of people who have entered the controlled area CA, by smoothing the changes in the data quantity and counting the number of times that the decision condition that the smoothed data quantity has increased across a certain threshold is satisfied.

As a means of smoothing, the data quantity is accumulated over each fixed period (unit time), and the accumulated data quantity for each period (FIG. 7(b) and FIG. 8(b)) is compared with the threshold. For example, using the accumulated data quantity D5(n) for each period and the accumulated data quantity D5(n−1) for the immediately preceding period, if the relationship with the threshold D63 given in the above expression (1) is satisfied, it is determined that a single person has entered. As noted earlier, the ‘accumulated data quantity (D5)’ will also be referred to as the ‘data quantity for each period (D5)’, or simply the ‘data quantity (D5)’.

The threshold D63 is preferably set about midway between the data quantity (substantially zero) when motion is absent and the data quantity when motion is present. Therefore, the threshold setting unit 63 stores, in an internal storage unit (not shown), the maximum value and the minimum value of the data quantity D5 input from the data quantity measurement unit 5 and automatically sets the threshold D63 to a value intermediate between the maximum value and the minimum value.

Specifically, the threshold D63 may be updated using the maximum value and the minimum value of the data quantity D5 in each prescribed interval. It is also possible to retain the maximum value and the minimum value of the data quantity D5 up to the present, and recalculate the threshold D63 when a value greater than the retained maximum value occurs, making it the new maximum value, or when a value less than the retained minimum value occurs, making it the new minimum value.

It is also possible to measure the data quantity in advance when there is no person in the camera's field of view and use this as the minimum value.

The above expression (1) is satisfied when the latest data quantity D5(n) is greater than the threshold D63 and the immediately preceding data quantity D5(n−1) is less than the threshold D63. That is, if the threshold D63 is set at a value intermediate between the maximum value and the minimum value of the data quantity D5, then the expression (1) is satisfied when the data quantity D5 increases across the threshold D63 as shown in FIGS. 7(b) and 8(b). As noted above, the data quantity increases when a subject, such as a person, enters the field of view of the camera, when the subject moves through the field of view, and when the subject leaves the field of view, and the data quantity is accumulated only when the door 9 is in the unlocked state, so that if the camera 2 is installed so as to be capable of imaging a person entering the controlled area CA, as shown in FIG. 2, entry of the person into the controlled area CA can be determined when the expression (1) is satisfied.

When the alarm output notification D6 from the comparison/determination unit 6 becomes ‘1’, or when the door open/close information D4 from the door control unit 4 is ‘1’ for a prescribed time or longer, the alarm output unit 7 outputs the alarm driving signal D7. The audible alarm generator 8 generates an audible alarm responsive to the alarm driving signal D7.

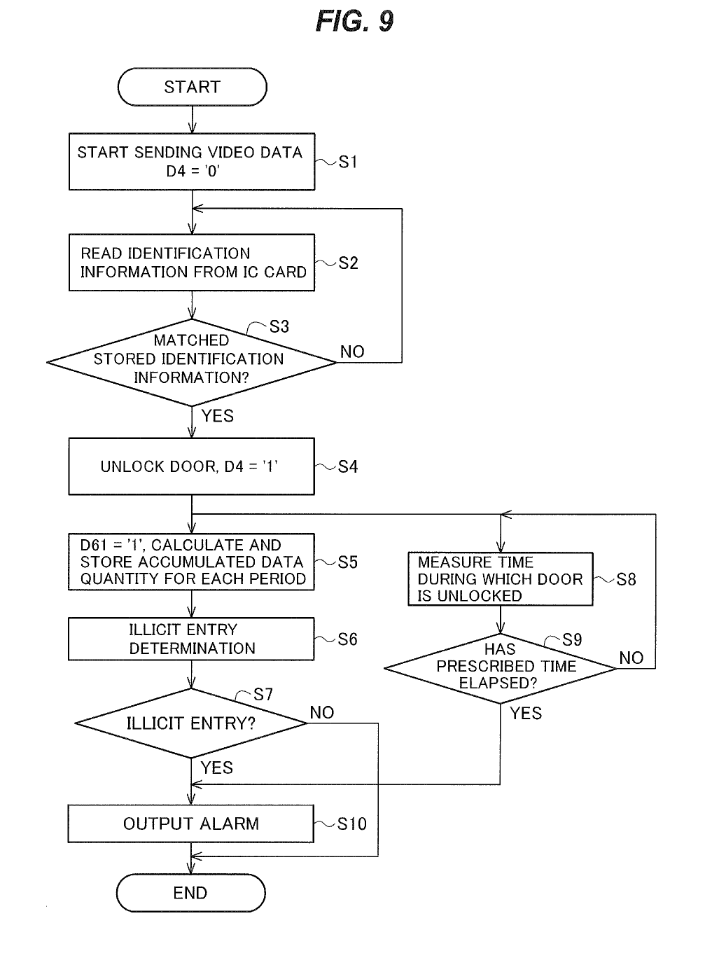

Next, the operation of the monitoring device 100 provided with the monitor information processing device 1 in this embodiment will be described with reference to the flowchart in FIG. 9.

As described earlier, a person entering the controlled area CA must approach the authentication unit 3 and place an IC card over it. The process in FIG. 5 starts when the authentication unit 3 begins reading the IC card.

When the process in FIG. 5 starts, in step S1, transmission of video data obtained through imaging by the camera 2 to the monitor information processing device 1 begins, and the data quantity measurement unit 5 in the monitor information processing device 1 starts receiving the video data D2. As a default setting, the information (door open/close information) D4 indicating whether the door 9 is in the unlocked state or not is set to ‘0’ (indicating the locked state).

As described above, when an IC card is placed over the card reader 3a, the authentication unit 3 reads the identification information stored in the IC card (step S2).

Next, the authentication unit 3 determines whether the read identification information matches any of the internally prestored identification information (whether the identification information read from the IC card is included in the list of identification information prestored in the authentication unit 3) (step S3), and outputs the authentication result information D3 indicating the result of this determination. If the identification information matches, the authentication result information D3 indicates that entry is permitted. If the identification information does not match, the authentication result information D3 indicates that entry is not permitted.

When entry is permitted by the determination in step S3 (Yes in step S3), the door control unit 4 unlocks the door 9 and sets the door open/close information D4 to ‘1’, then outputs this information to the monitor information processing device 1 (step S4).

When entry is not permitted by the determination in step S3 (No in step S3), the door 9 is not unlocked, the door open/close information is left as ‘0’, and the process returns to step S2.

In step S5 following step S4, the entry permission counting unit 61 in the comparison/determination unit 6 sets the count value D61 to ‘1’. The data quantity measurement unit 5 repeatedly performs the process of calculating the data quantity of the video data included in the IP packet output from the camera 2 and determining the accumulated value of the calculated data quantity over one period (data quantity for each period).

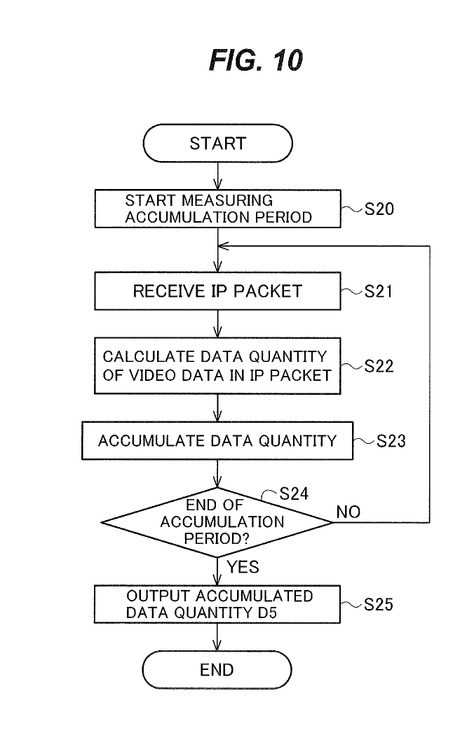

The operation of the data quantity measurement unit 5 in step S5 will be described in detail with reference to FIG. 10.

When the processing in step S5 starts, the period measurement unit 51 starts measuring the accumulation period (step S20).

The measurement of the accumulation period may be performed by a counting unit for counting an operation clock output from an oscillator provided in the monitor information processing device 1 or, if timestamps are stored in the video data D2 input from the camera 2, it may be performed with reference to the timestamps.

Next, the packet length calculation unit 52 receives an IP packet of encoded video data D2 input from the camera 2 (step S21) and calculates the data quantity of the video data D2 included in the IP packet from the packet header information (the packet size and the header size) of the IP packet (step S22), and the data quantity accumulation unit 53 adds the calculated data quantity of the video data to the accumulated data quantity D5, which is stored so far in the accumulated data quantity storage unit 531, thereby determines a new accumulated data quantity D5, and rewrites the accumulated data quantity D5 in the accumulated data quantity storage unit 531 (step S23).

Next, whether the time measured by the period measurement unit 51 has reached the unit time (accumulation period) is determined (S24), and if it has not (No in step S24), the process returns to step S21.

The process in steps S21 to S24 is repeated until it is determined in step S24 that the unit time (accumulation period) has been reached. The data quantity of the video data included in an IP packet newly received in step S22 is added in step S23 to the data quantity stored in the accumulated data quantity storage unit 531 (the value accumulated so far). As a result of iteration of this process, the data quantities of the video data included in the IP packets transmitted from the camera 2 are accumulated.

When the time measured by the period measurement unit 51 reaches the unit time (accumulation period) (Yes in step S24), the data quantity accumulation unit 53 outputs the accumulated data quantity D5 stored so far in the accumulated data quantity storage unit 531 to the comparison/determination unit 6 (step S25).

After outputting the accumulated data quantity D5, the data quantity accumulation unit 53 resets the accumulated data quantity stored in the accumulated data quantity storage unit 531 to zero (S26).

After step S25, the process returns to step S20 and the series of steps starting from step S20 is repeated again.

Returning to FIG. 9, in step S5, the data quantity D5 for each period obtained by the above operation is input to the comparison/determination unit 6, which determines whether illicit entry has occurred on the basis of the input data quantity D5 (step S6).

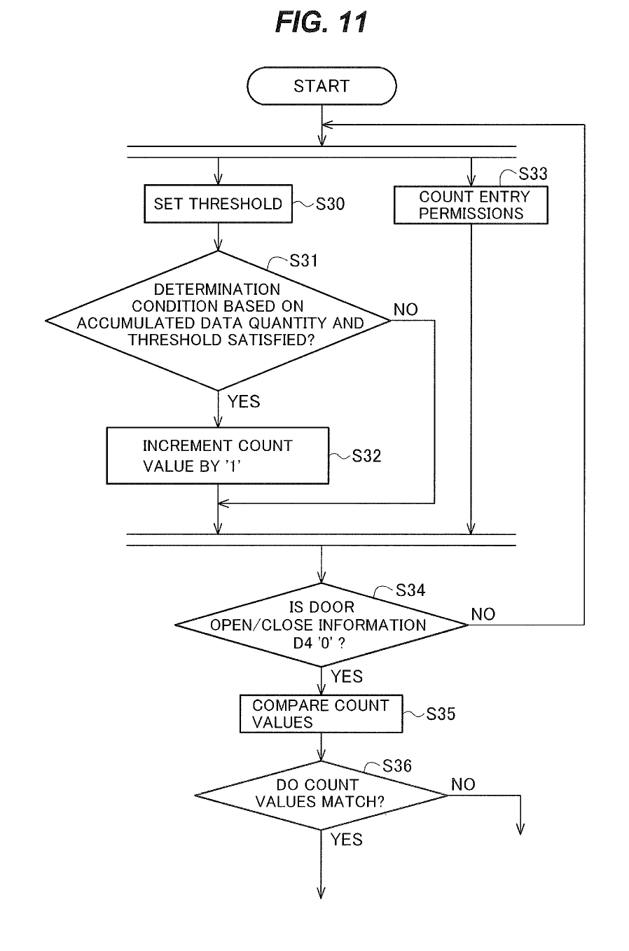

The operation of the comparison/determination unit 6 in steps S6 and S7 will be described in detail with reference to FIG. 11.

Steps S30 to S35 in FIG. 11 constitute step S6 in FIG. 9, and step S36 constitutes step S7.

In step S30, the threshold setting unit 63 sets the threshold D63. The threshold D63 is used for comparison with the data quantity D5 for each period, and, on the basis of the comparison result, whether a transit by a person has taken place is determined.

Next, the accumulated data quantity analysis unit 62 retains, in the data amount storage unit 621, the two most recent values among the values of the data quantity D5 input from the data quantity measurement unit 5, and compares the two values D5(n) and D5(n−1) with the threshold D63. Specifically, whether the values satisfy the condition represented by the expression (1) is determined (step S31).

If the expression (1) is satisfied in step S31, the process proceeds to step S32, in which the accumulated data quantity analysis unit 62 increments, by 1, the count value in the counting unit 622, which counts the number of times that the expression (1) is satisfied, and then the process proceeds to step S34. If the expression (1) is not satisfied in step S31, the process proceeds directly to step S34.

In step S33, which is performed in parallel with steps S30, S31, and 32, the entry permission counting unit 61 counts the number of times that the authentication result information D3 indicating entry permission is input during the time when the door 9 is in the unlocked state, on the basis of the authentication result information D3 input from the authentication unit 3 and the door open/close information D4, and outputs the count value D61 to the illicitness determination unit 64.

After steps S30 to S33, whether the door open/close information D4 indicates ‘0’ is determined in step S34; if it is not ‘0’, the process returns to step S30. The process in steps S30 to S33 is accordingly iterated as long as the door open/close information D4 indicates ‘1’ (indicating that the door is in the unlocked state) (i.e., as long as the determination result in step S34 is No).

When the door 9 is turned into the locked state and the door open/close information D4 becomes ‘0’ (Yes in step S34), the illicitness determination unit 64 compares the count value D61 from the entry permission counting unit 61 (the value obtained by adding 1 to the number of times the authentication result information D3 indicating entry permission occurred while the door open/close information D4 was ‘1’) with the count value D62 from the counting unit 622 in the accumulated data quantity analysis unit 62 (the number of times that the expression (1) was satisfied) (step S35).

After the process in step S35, the count value D61 in the comparison/determination unit 6, the accumulated data quantity D5 held in the data quantity storage unit 621 in the accumulated data quantity analysis unit 62, and the count value D62 held in the counting unit 622 in the accumulated data quantity analysis unit 62 are reset to 0.

The data quantity storage unit 621 need only be configured to store the two most recent accumulated data quantities; for example, one possible configuration is to overwrite the earlier one of the stored accumulated data quantities whenever the accumulated data quantity is input. In such a configuration, the reset of the accumulated data quantity in step S35 need not be performed.

The determination (step S36) made on the basis of the comparison between the count value D61 and the count value D62 in step S35 corresponds to the determination in step S7 in FIG. 9. Specifically, if a match is found in step S36 (Yes in step S36), the result of the determination in step S7 in FIG. 9 is that ‘no illicit entry has occurred’ (No); if an unmatch is found (No in step S36), the result of the determination in step S7 in FIG. 9 is that ‘illicit entry has occurred’ (Yes).

Returning to FIG. 9, if no illicit entry is determined to have occurred in step S7 (No in step S7), the process ends. If an illicit entry is determined to have occurred in step S7 (Yes in step S7), the process proceeds to step S10.

In parallel with steps S5 to S7, the process in steps S8 and S9 is performed.

In step S8, the alarm output unit 7 measures the time during which the door open/close information D4 is ‘1’. The measurement of the time is performed using a timer generated on the basis of the clock used by the monitor information processing device 1; when the timer reaches a predetermined time (Yes in step S9), the process proceeds to step S10.

In step S10, the comparison/determination unit 6 outputs an alarm output notification D6 to the alarm output unit 7, and the alarm output unit 7 outputs an alarm driving signal D7 in response (step S10). The audible alarm driving signal D7 drives the audible alarm generator 8 to generate an audible alarm.

The audible alarm indicates that the comparison/determination unit 6 has determined that illicit entry has occurred or that the door 9 has been in the unlocked state for a long time and some abnormal situation has arisen.

In the example described above, illicit entry is determined to have occurred when the count value D61 in the entry permission counting unit 61 does not match the count value D62 in the counting unit 622 in the accumulated data quantity analysis unit 62. Illicit entry may however be determined to have occurred only when the count value D62 in the counting unit 622 in the accumulated data quantity analysis unit 62 exceeds the count value D61 in the entry permission counting unit 61.

In the example above, satisfaction of the expression (1) is tested to detect that the data quantity D5 has increased across the threshold D63. But instead, satisfaction of the following expression (2) may be tested to detect that the data quantity D5 has decreased across the threshold D63.

D5(n)<D63<D5(n−1) (2)

In order to count the number of people who have made entry, on the basis of the expression (1), it is desirable not to allow two people to enter the field of view at once, as is clear from the description given with reference to FIGS. 8(a) and 8(b). From this point of view, the field of view of the camera is preferably made narrow. Alternatively, instead of using all of the video data in each frame obtained from imaging by the camera 2, the data quantity of the video data of a part of each frame, the central part, for example, may be used to determine whether the expression (1) is satisfied or whether the expression (2) is satisfied. By so doing, the same effect can be obtained as by narrowing the field of view.

As described above, according to the first embodiment, in order to detect illicit entry (by tailgating) to the controlled area CA, the monitor information processing device 1 images people attempting to enter the controlled area CA with the camera 2, receives the encoded video data D2 from the camera 2, and detects the number of people who have entered the controlled area CA, on the basis of changes in the data quantity of the received encoded video data D2. Accordingly, the process of decoding the encoded video data D2 is unnecessary. Consequently, there is no increased cost due to the use of a high-performance CPU to decode the video data D2 or increased number of parts due to the addition of special-purpose LSI circuit chips, and costs can be reduced.

In addition, according to the first embodiment, in order to detect illicit entry (by tailgating) to the controlled area CA, the monitor information processing device 1 detects the entry of a person by making a magnitude relation comparison between the accumulated data quantity D5 obtained from accumulation of the data quantities of the video data included in the IP packets over a fixed unit time and a threshold D63. Accordingly, the desired functions can be implemented with a simple software program or digital circuit. Consequently, complex image processing is unnecessary, there is no cost increase due to the use of a high-performance CPU or increased number of parts due to the addition of special-purpose LSI circuit chips, and costs can be reduced.

The first embodiment also includes an alarm output unit 7 that outputs an alarm when illicit entry is detected, so that those in the surrounding area can be reliably notified of the occurrence of illicit entry.

The first embodiment is also configured in such a way that the threshold D63 for the accumulated data quantity D5 can be automatically set to an optimal level, so that the entry of people can be detected with high precision.

The first embodiment is also configured in such a way that the measurement of the data quantity by the data quantity measurement unit 5 is performed only when the door 9 is in the unlocked state, so that false determinations made by using video data obtained when the door 9 is in the locked state, that is, using video images irrelevant to entry into the controlled area CA, can be prevented, thus enabling the entry of people to be detected with high precision.

### Second Embodiment

A case in which the invention is applied to control entry into a controlled area CA has been described above, but the monitor information processing device of the present invention may also be applied to control exit from a controlled area CA to a public area PA.

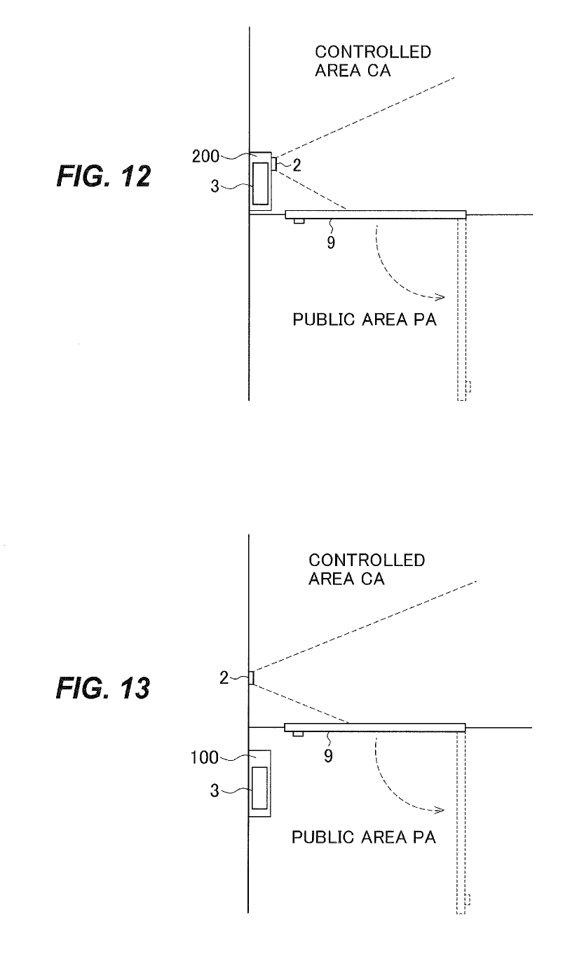

In order to perform exit control, it suffices to install a monitoring device 200 similar to the monitoring device 100 shown in FIGS. 1 and 2 on the controlled area CA side of the door 9, as shown in FIG. 12.

To summarize, the monitor information processing device of the present invention can be used to monitor movement or transit from one of the controlled area CA and the public area PA to the other.

### Third Embodiment

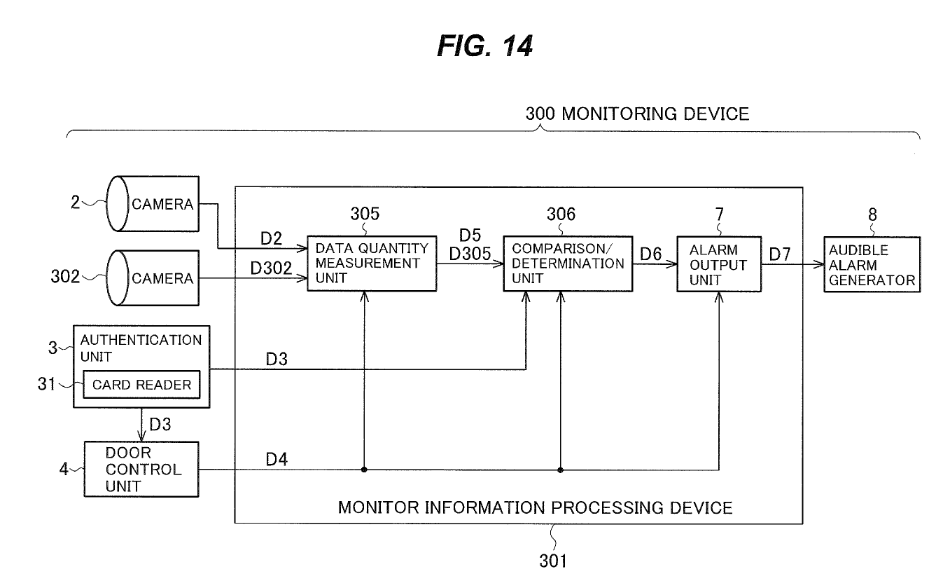

In the first embodiment, the camera is provided on the public area PA side. But, as shown in FIG. 13, the camera may be provided within the controlled area CA and installed to image people coming through the door 9 and having entered the controlled area CA, that is, positioned so that the camera's field of view covers the area passed through by people having entered the controlled area CA.

With the arrangement in FIG. 2, a person who enters the field of view of the camera 2 in the public area PA while the door 9 is in the unlocked state and then departs without entering the controlled area CA is also counted. If the camera is installed as in FIG. 13, only people who have entered the controlled area CA can be counted.

### Fourth Embodiment

That a person has entered the controlled area CA from the public area PA may also be determined by installing cameras on both the public area PA side as in FIG. 2 and the controlled area CA side as in FIG. 13 and making the determination based on both cameras' data quantities.

That a person has entered the controlled area CA from the public area PA may be determined when, for example, the decision condition that the data quantity of the camera on the controlled area CA side has increased across the threshold is satisfied within a fixed time after the decision condition that the data quantity of the camera on the public area PA side has increased across the threshold is satisfied.

The configuration of the monitoring device in this case is shown in FIG. 14. The illustrated monitoring device 300 includes two cameras 2, 302. The camera 2 is similar to the camera shown in FIGS. 1 and 2 and is located on the public area PA side. The camera 302 is located on the controlled area CA side, as is the camera 2 in FIG. 13, and is positioned in such a way as to image people who have transited the door 9 and entered the controlled area CA.

A data quantity measurement unit 305 is similar to the data quantity measurement unit 5 in FIG. 1, but receives not only encoded video data D2 from the camera 2 but also encoded video data D302 from the camera 302, measures their respective data quantities, and outputs accumulated data quantities D5 and D305.

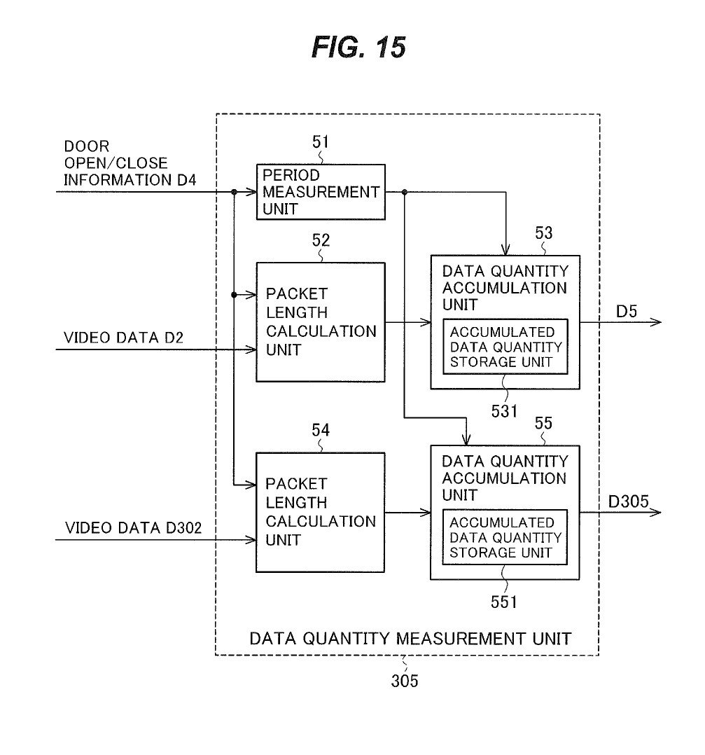

The data quantity measurement unit 305 is configured, for example, as shown in FIG. 15. Reference characters in FIG. 15 that are the same as in FIG. 3 indicate similar elements.

A packet length calculation unit 54 is similar to the packet length calculation unit 52, but extracts information indicating the packet length and information indicating the header length from each IP packet constituting the encoded video data input from the camera 302 while the door 9 is held unlocked by the door control unit 4, and subtracts the header length from the packet length to calculate the data quantity of the video data included in the IP packet.

A data quantity accumulation unit 55 is similar to the data quantity accumulation unit 53, but accumulates, in an internal accumulated data quantity storage unit 551, the data quantities output from the packet length calculation unit 54 over a period measured by the period measurement unit 51, thereby determines the accumulated value for each period, and outputs it as the accumulated data quantity D305.

The comparison/determination unit 306 determines whether illicit entry has occurred on the basis of the accumulated data quantities D5 and D305 that were input from the data quantity measurement unit 305 and the number of times D32 that the authentication result information D3 indicating entry permission was output by the authentication unit 3, while the door 9 was indicated to be in the unlocked state by the door open/close information D4 from the door control unit 4, and reports the result of its determination to the alarm output unit 7.

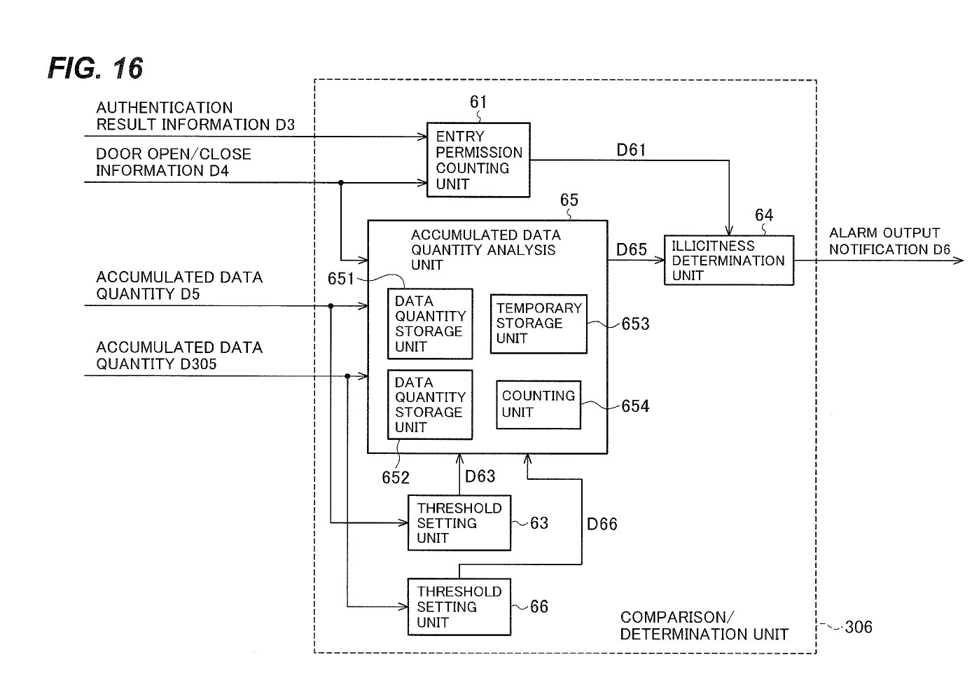

The comparison/determination unit 306 is configured, for example, as shown in FIG. 16. Reference characters in FIG. 16 that are the same as in FIG. 5 indicate similar elements.

An accumulated data quantity analysis unit 65 analyzes the data quantities D5 and D305 for each period measured by the data quantity measurement unit 305.

Specifically, like the accumulated data quantity analysis unit 62 in FIG. 5, the accumulated data quantity analysis unit 65 stores the data quantity D5(n) for the most recent accumulation period and the data quantity D5(n−1) for the immediately preceding accumulation period from the data quantity measurement unit 305, in a data quantity storage unit 651 (similar to the data quantity storage unit 621 in FIG. 5), and determines, whether a threshold D63 input from a threshold setting unit 63, the data quantity D5(n) in the most recent accumulation period and the data quantity D5(n−1) in the immediately preceding accumulation period satisfy the decision condition that the threshold D63 is crossed in the increasing direction, while the door open/close information D4 is ‘1’, that is, whether the above expression (1) is satisfied.

The accumulated data quantity analysis unit 65 in FIG. 16 also includes a data quantity storage unit 652 for storing the data quantity D305 for each period input from the data quantity measurement unit 305, in which data quantity D305(n) in the most recent accumulation period and data quantity D305(n−1) in the immediately preceding accumulation period are stored.

The accumulated data quantity analysis unit 65 determines whether a threshold D66 input from a threshold setting unit 66, the data quantity D305(n) in the most recent accumulation period, and the data quantity D305(n−1) in the immediately preceding accumulation period satisfy the decision condition that the threshold D66 is crossed in the increasing direction while the door open/close information D4 is ‘1’, that is, whether the following expression (3) is satisfied:

D305(n)>D66>D305(n−1) (3)

The threshold D66 is set by the threshold setting unit 66. To determine the threshold D66, the threshold setting unit 66, which is configured in the same way as the threshold setting unit 63, performs the same process as the threshold setting unit 63, on the basis of the data quantity D305 instead of the data quantity D5.

The accumulated data quantity analysis unit 65 determines whether the expression (3) is satisfied within a fixed time after the expression (1) given earlier is satisfied.

This determination can be made by, for example, when the expression (1) is satisfied, storing information indicating that fact in the temporary storage unit 653, retaining the stored content in the temporary storage unit 653 for only a fixed time, and determining whether a signal indicating that the expression (3) is satisfied is generated while the stored content is retained.

The above fixed time is set at the maximum time expected to be taken by a person to move from the field of view of the camera 2 in the public area PA to the field of view of the camera 302 in the controlled area CA, or that time plus a slight margin.

A counting unit 654 counts the number of times that the expression (2) is satisfied within the fixed time after the expression (1) is satisfied, and outputs the count result as a count value D362.

When the door open/close information D4 becomes ‘0’, the accumulated data quantity analysis unit 65 outputs the count value D65 to the illicitness determination unit 64.

After outputting the count value D65, the accumulated data quantity analysis unit 65 resets the count value D65 stored in the counting unit 654 to 0.

With regard to other points, the monitoring device in FIGS. 14 to 16 operates in the same way as the monitoring device described with reference to FIGS. 1 to 11.

With the above configuration, a single person is determined to have entered the controlled area CA from the public area PA when the data quantity from the camera on the controlled area CA side is determined to satisfy the expression (3), which is similar to the expression (1), within a fixed time after the data quantity from the camera on the public area PA side has satisfied the expression (1), so that transit of a person from the public area PA into the controlled area CA can thereby be detected more reliably. That is, the possibility of false detection of a person who departs without entering the controlled area as a person who has entered the controlled area can be lowered.

### Fifth Embodiment

In the above embodiments, as shown in FIGS. 6(a) to 6(h), tailgating is detected when a person exits the field of view of the camera and then another person enters the field of view of the camera. The following will describe a monitor information processing device capable of detecting tailgating even when people move in tandem with no gap between them. As in the first embodiment, the case of a person moving from the public area PA into the controlled area CA will be described below.

The overall configuration of the monitoring information processing device of this embodiment is as shown in FIG. 1. In place of the comparison/determination unit 6 in FIG. 1, a comparison/determination unit 406 is provided.

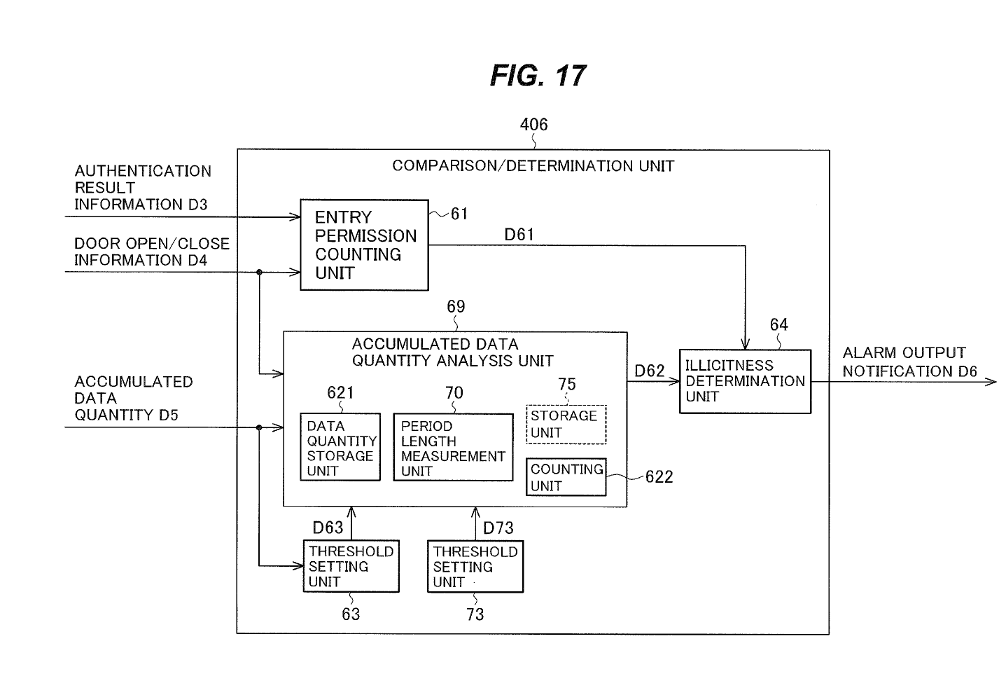

FIG. 17 shows the configuration of the comparison/determination unit 406 used by the monitor information processing device in the fifth embodiment. The comparison/determination unit 406 in FIG. 17 is generally the same as the comparison/determination unit 6 in FIG. 5, but the accumulated data quantity analysis unit 62 is replaced with an accumulated data quantity analysis unit 69, and a threshold setting unit 73 is added.

The accumulated data quantity analysis unit 69 is generally the same as the accumulated data quantity analysis unit 62 but differs in that a period length measurement unit 70 is added.

The period length measurement unit 70 measures the length (time span) D70 of the interval during which the data quantity D5 is, continuously greater than the threshold D63 while the door open/close information D4 is ‘1’, on the basis of the data quantity D5 obtained by accumulation in the data quantity measurement unit 5 and the threshold D63 set by the threshold setting unit 63.

The changes in the data quantity that take place when people move in tandem with no gap between them from the public area PA to the controlled area CA, that is, when a person enters the field of view of the camera and then, before that person leaves the field of view, a second person enters the field of view, after which the first and the second people leave the field of view in succession will now be described.

The camera 2 is assumed to be installed in the position shown in FIG. 2, for example.

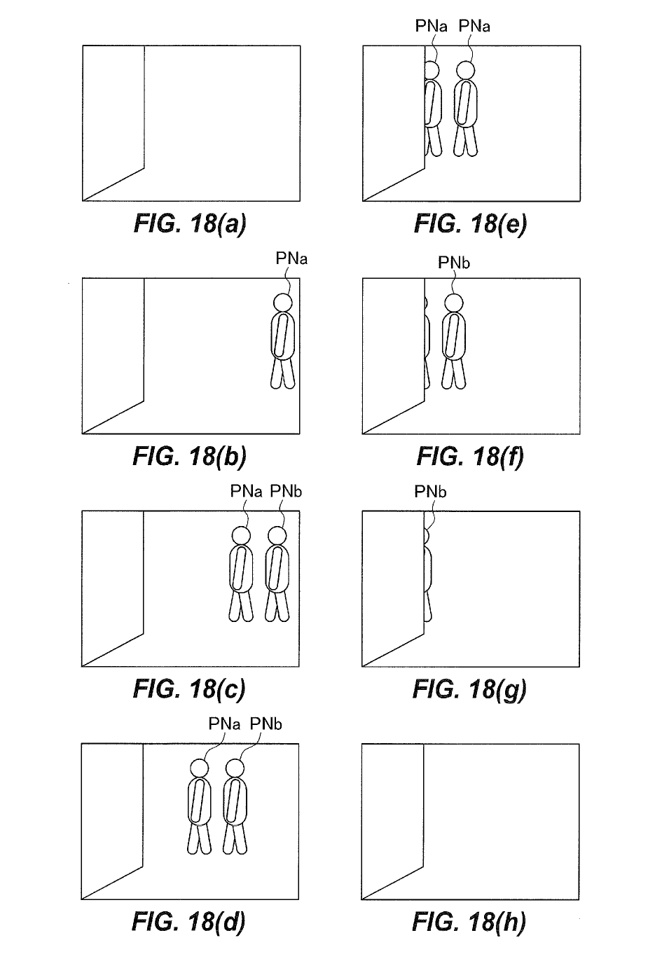

FIGS. 18(a) to 18(h) are diagrams showing exemplary consecutive frame images captured by the camera 2 when people move in tandem with no gap between them from the public area PA side to the controlled area CA side. The frame rate is 10 fps to 30 fps, for example; FIGS. 18(b) to 18(h) show images that respectively follow those in FIGS. 18(a) to 18(g) by several frames. That is, starting from the state (FIG. 18(a)) in which there is no one in the field of view of the camera (no person is imaged), how a person PNa and a person PNb appear in succession and enter the controlled area CA with no gap between them is shown (FIGS. 18(b) to 18(g)).

As noted above, when the camera 2 compresses video data by an encoding system such as H.264, when appearance, movement or the like of a subject occurs, the interframe differences increase, and hence the quantity of encoded data increases.

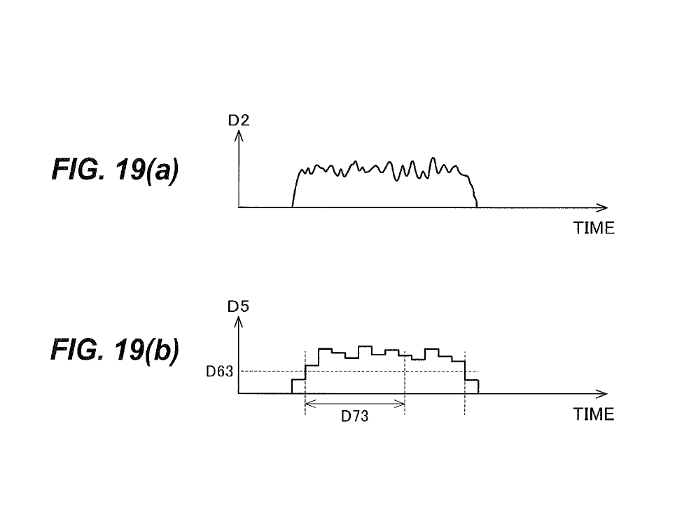

FIG. 19(a) shows exemplary changes in the data quantity of the video data when the two people shown in FIG. 18 enter the camera's field of view with no gap between them, then move through the field of view and leave; FIG. 19(b) shows changes in the accumulated data quantity obtained by accumulating the data quantities in FIG. 19(a) over each fixed period.

As shown in FIG. 19(a), the data quantity is substantially zero when no one is in the field of view; it increases when the person PNa appears and then, when the person PNb appears, remains large even after the person PNa disappears, until the person PNb disappears, and returns to zero after the person PNb disappears. In the example shown in FIG. 8, since the person PNa leaves the field of view before the next person PNb enters the field of view, there is a time during which the data quantity becomes zero or nearly zero after the person PNa leaves the field of view, until the next person PNb enters the field of view. But when the two people PNa and PNb move with no gap between them as shown in FIG. 18, the change in the data quantity is as shown in FIG. 19(a), for example, in which the data quantity does not become zero or nearly zero between the two people. Therefore, from the change in the data quantity, it is impossible to distinguish the transit of a single person (shown in FIG. 7(a)) from the transit of two people with no gap between them (shown in FIG. 19(a)).

Thus, if FIGS. 7(a) and 19(a) are compared, it can be seen that FIGS. 7(a) and 19(a) both include only one hill-shaped change in the data quantity. But there is a difference in the width of the hill (the length of the interval during which the data quantity maintains a large value). That is, since two people enter the field of view in succession, the length of the interval during which at least one person is present in the field of view becomes longer, which accordingly increases the length of the interval during which the data quantity D2 maintains a large value.

To detect tailgating, this embodiment detects tailgating based not only on changes in the data quantity but also on the length of the interval during which the data quantity maintains a large value.

Specifically, the number of times that people have transited the field of view of the camera, thus the number of people who have entered the controlled area CA, is counted by smoothing the changes in the data quantity, counting the number of times the condition that the smoothed data quantity has increased across a prescribed threshold is satisfied, and measuring the length of the interval during which the smoothed data quantity is continuously greater than a prescribed threshold.

As a means of the smoothing, as described in the first embodiment, the data quantity is accumulated over a fixed period (unit time) and the data quantity D5 for each period and the threshold D63 are compared. When the length (time span) D70 of the interval during which the data quantity D5 is continuously greater than the threshold D63 has exceeded a predetermined threshold (interval length threshold) D73, the count value of people who have entered the controlled area CA is incremented by 1. As a result of this process, the number of people is counted as two in the example shown in FIGS. 19(a) and 19(b).

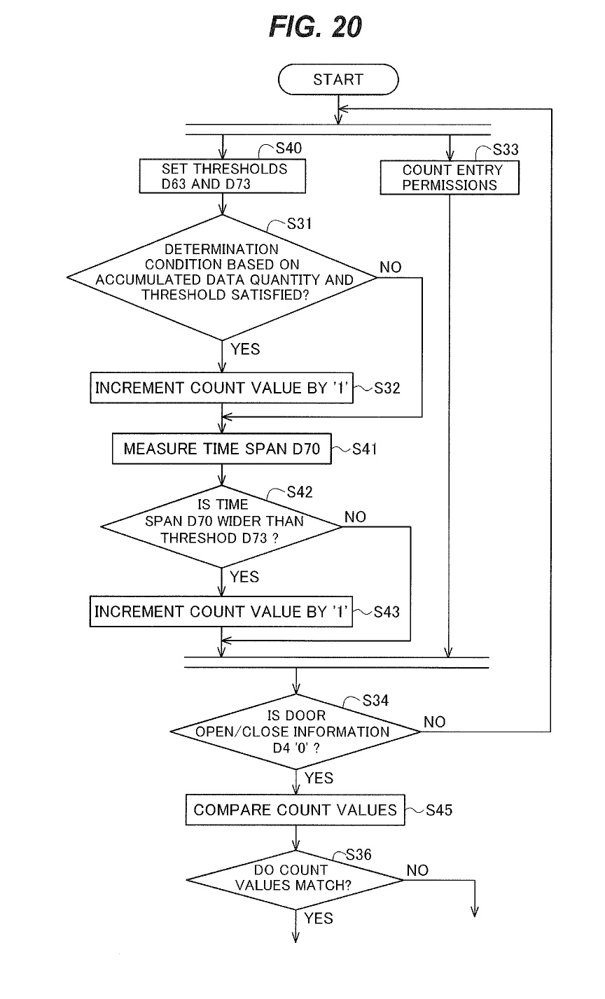

Next, the operation of the comparison/determination unit 406 in this embodiment will be described with reference to the flowchart in FIG. 20. FIG. 20 differs from FIG. 11 in that steps S40 and S45 are provided in place of steps S30 and S35 and steps S41, S42, and S43 are added; in other regards, FIG. 20 is the same as FIG. 11.

First, in step S40, the threshold setting unit 63 sets the thresholds D63 and D73.

With regard to the threshold D63, the maximum value and the minimum value of the accumulated data quantity input from the data quantity measurement unit 5 are retained in an internal storage unit (not shown), and the threshold D63 is automatically set to a value intermediate between the maximum value and the minimum value as described earlier.

Specifically, the threshold D63 may be updated using the maximum value and the minimum value of the data quantity D5 in each prescribed interval. It is also possible to retain the maximum value and the minimum value of the data quantity D5 up to the present, and recalculate the threshold D63 when a value greater than the retained maximum value occurs, making it the new maximum value, or when a value less than the retained minimum value occurs, making it the new minimum value.

It is also possible to measure the data quantity in advance when there is no person in the camera's field of view and use this as the minimum value.

The threshold D73 is preferably set to a value intermediate between the length D70 of the interval (the single-person transit time span) during which the data quantity D5 is continuously greater than the threshold D63 when a person transits the camera's field of view, e.g., when a single person moves to the controlled area CA side, and the length D70 of the interval (the two-person transit time span) during which the data quantity D5 is continuously greater than the threshold D63 when two people move to the controlled area CA side with no gap between them.

In this case, the ‘single-person transit time span’ and the ‘two-person transit time span’ are determined by performing tests. Specifically, the process of measuring the length (time span) D70 of the interval during which the data quantity D5 is continuously greater than the threshold D63, in a state in which it can be confirmed in another way that a single person is transiting is performed one or more times, and the ‘time span for a single-person transit’ is determined on the basis of the measurement result(s) (e.g., by taking their mean value or median value if multiple measurement results have been obtained).

Similarly, the process of measuring the length (time span) D70 of the interval during which the data quantity D5 is continuously greater than the threshold D63 in a state in which it can be confirmed in another way that two people are transiting with no gap between them is performed one or more times, and the ‘time span for a two-person transit’ is determined on the basis of the measurement result(s) (e.g., by taking their mean value or median value if multiple measurement results have been obtained).

When there are individual differences in the ‘time span for a single-person transit’, a threshold D73 may be set for each individual. Specifically, a threshold D73 may be set and stored for each ID read by the card reader 31 in the authentication unit 3.

For example, the threshold D73 may be determined by tests similar to those described above.

Specifically, after the ID card of a prospective user is read by the card reader 31, the prospective user is made to move alone (i.e., without occurrence of tailgating), the time span (length of the interval during which the data quantity D5 is continuously greater than the threshold D63) during his/her movement is measured, and the measurement result is stored in association with the read ID. This test measurement is performed one or more times, and on the basis of the measurement result(s), the threshold D73 is determined and stored, for example, in a storage unit 75 (shown in dotted lines in FIG. 17) in association with the ID.

During actual operation (monitoring), when the ID card of a person who attempts to transit is read by the card reader 31, whether a threshold D73 associated with the read ID is already stored in the storage unit 75 is determined; if one is already stored, the stored threshold D73 is used to determine the presence or absence of tailgating.

By setting a threshold D73 for each individual in this way, false determination of the presence or absence of tailgating can be reduced even when there are individual differences in transit time.

Instead of determining a threshold D73 for each ID by tests as described above, the threshold D73 may be determined as follows on the basis of the data obtained during actual operation. Specifically, the first time each ID is used for authentication, the time span D70 (length of the interval during which the data quantity D5 is continuously greater than the threshold D63) is measured on the assumption of a single-person transit, and the measurement result is stored.

After that, the measured value of the time span may be stored whenever authentication and transit are performed with the same ID, and a value obtained by multiplying the minimum of the measured values of two or more stored time spans by a coefficient equal to or greater than 1 may be used as the threshold D73. Alternatively, the median value of three or more measured time spans may be set as the threshold D73.

The threshold D73 may be set in this way because tailgating seldom occurs, and the first time each ID is used to transit, the person using the ID can be expected to pay attention to what is going on around him/her and not allow tailgating to take place.

By setting a threshold D73 for each ID as above, it is possible to prevent false detection or failure of detection due to individual differences in the length of the interval during which the data quantity D5 is continuously greater than the threshold D63 during a transit.

Returning to the flowchart in FIG. 20, in step S31, whether changes in the data quantity D5 satisfy the condition represented by the expression (1) is determined in the same way as is described in the first embodiment.

If it is determined that the condition represented by the expression (1) is satisfied in step S31, the process proceeds to step S32.

In step S32, the count value in the counting unit 622 is incremented by 1, after which the process proceeds to step S41.

If it is determined that the condition represented by the expression (1) is not satisfied in step S31, the process proceeds directly to step S41.

In step S41, the length (time span) D70 of the interval during which the data quantity D5 is continuously greater than the threshold D63 is measured by the period length measurement unit 70. The measurement of the time span may be performed by incrementing a counter, or by using a timer or the like.

In step S42, whether the time span D70 measured in step S41 is greater than the threshold D73 is determined. If the measured time span D70 is greater than the threshold D73, it is determined that people are moving in tandem with no gap between them as shown in FIG. 19, the count value is incremented by 1 in step S43, and the process proceeds to step S34. If the measured time span D70 is equal to or less than the threshold D73, the process proceeds directly to step S34.

In step S33, which is performed in parallel with steps S40, S31, S32, S41, S42, and S43, the entry permission counting unit 61 counts the number of times that the authentication result information D3 indicating entry permission is input during the time while the door 9 is in the unlocked state, on the basis of the authentication result information D3 input from the authentication unit 3 and the door open/close information D4, and outputs the count value D61 to the illicitness determination unit 64.

In step S34, whether the door open/close information D4 is ‘0’ is determined; if it is not ‘0’, the process returns to step S30. The process in steps S31 to S33 and S40 to S43 is accordingly iterated as long as the door open/close information D4 is ‘1’ (indicating that the door is in the unlocked state) (i.e., as long as the determination result in step S34 is No).

When the door 9 is turned into the locked state and the door open/close information D4 becomes ‘0’ (Yes in step S34), the process proceeds to step S45.

In step S45, the illicitness determination unit 64 compares the count value D61 (the value obtained by adding 1 to the number of times that the authentication result information D3 indicating entry permission occurred while the door open/close information D4 was ‘1’) in the entry permission counting unit 61 with the count value D62 (the number of times that the expression (1) was satisfied) in the counting unit 622 in the accumulated data quantity analysis unit 62.

The count value D62 in the counting unit 622 indicates the sum of the number of times that the expression (1) was satisfied and the number of times that the length of the interval during which the data quantity D5 was continuously greater than the threshold D63 exceeded the threshold D73.

The determination (step S36) made on the basis of the comparison between the count value D61 and the count value D62 in step S45 corresponds to the determination in step S7 in FIG. 9. Specifically, if a match is found in step S36 (Yes in step S36), the result of the determination in step S7 in FIG. 9 is that ‘no illicit entry has occurred’ (No); if an unmatch is found (No in step S36), the result of the determination in step S7 in FIG. 9 is that ‘illicit entry has occurred’ (Yes).

As described above, according to the fifth embodiment, in order to detect illicit entry (by tailgating) to the controlled area CA, the monitor information processing device 1 images people attempting to enter the controlled area CA with the camera 2, receives the encoded video data D2 from the camera 2, and detects the number of people who have entered the controlled area CA, on the basis of the data quantity of the received encoded video data D2. Accordingly, the process of decoding the encoded video data D2 is unnecessary. Consequently, there is no increased cost due to the use of a high-performance CPU to decode the video data D2 or increased number of parts due to the addition of special-purpose LSI circuit chips, and costs can be reduced.

In addition, according to the fifth embodiment, in order to detect illicit entry (by tailgating) to the controlled area CA, the monitor information processing device 1 detects the entry of a person by making a magnitude relation comparison between the accumulated data quantity D5 obtained from accumulation of the data quantities of the video data included in the IP packets over a fixed unit time and a threshold D63. Accordingly, the desired functions can be implemented with a simple software program or digital circuit. Consequently, complex image processing is unnecessary, there is no cost increase due to the use of a high-performance CPU or increased number of parts due to the addition of special-purpose LSI circuit chips, and costs can be reduced.

Also, according to the fifth embodiment, in order to detect illicit entry (by tailgating) to the controlled area CA, the monitor information processing device 1 measures the length (time span) D70 of the interval during which the accumulated data quantity D5 obtained by accumulating the data quantities of the video data included in the IP packets over a fixed unit time is continuously greater than the threshold D63, and counts people who have entered, on the basis of the result of a comparison between the measured time span D70 and the threshold D73. Therefore, illicit entry can be accurately detected even when multiple people transit with no gap between them.

The fifth embodiment also includes an alarm output unit 7 that outputs an alarm when illicit entry is detected, so that those in the surrounding area can be reliably notified of the occurrence of illicit entry.

The fifth embodiment is also configured in such a way that the threshold D63 for the accumulated data quantity D5 can be automatically set to an optimal level, so that the entry of people can be detected with high precision.

Also, when a threshold D73 for the time span is set for each individual, even if there are individual differences in transit time, a more precise determination of the presence or absence of tailgating can be made.

The fifth embodiment is also configured in such a way that the measurement of the data quantity by the data quantity measurement unit 5 is performed only when the door 9 is in the unlocked state, so that false determinations made by using video data obtained when the door 9 is in the locked state, that is, using video images irrelevant to entry to the controlled area CA, can be prevented, thus enabling the entry of people to be detected with high precision.

### Sixth Embodiment

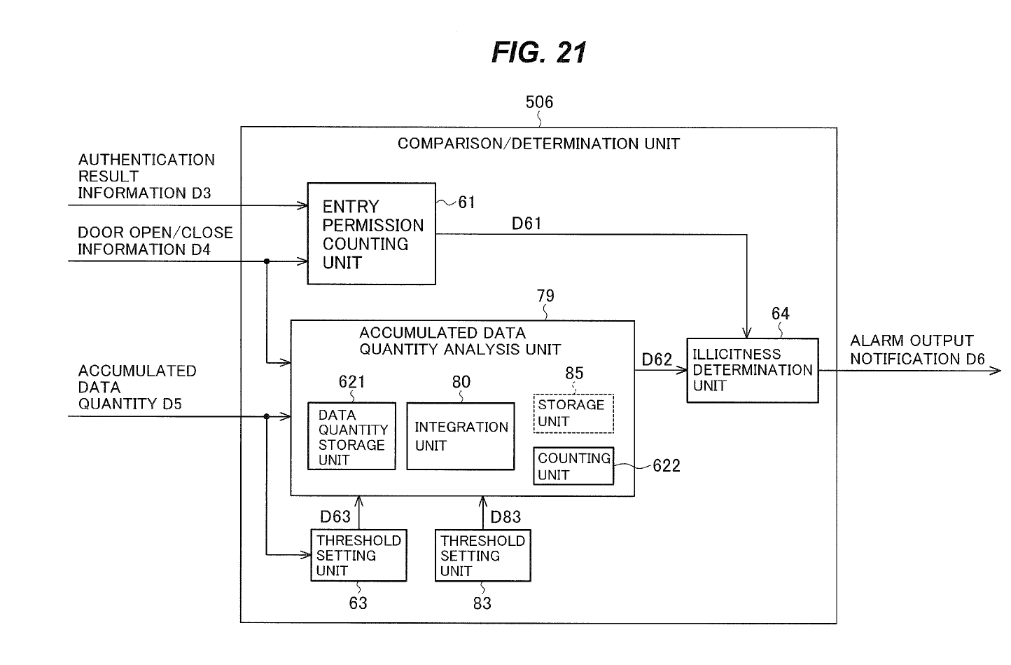

In the fifth embodiment, illicit entry is detected from the lengths (time spans) D70 of intervals during which the accumulated data quantity D5 is continuously greater than a threshold D63. In the sixth embodiment, illicit entry is detected using an integration unit 80 as shown in FIG. 21.

FIG. 21 shows the configuration of a comparison/determination unit 506 used in the monitor information processing device in the sixth embodiment. The comparison/determination unit 506 in FIG. 21 is generally the same as the comparison/determination unit 406 in FIG. 17, but it includes an accumulated data quantity analysis unit 79 and a threshold setting unit 83, instead of the accumulated data quantity analysis unit 69 and the threshold setting unit 73.

The accumulated data quantity analysis unit 79 is generally the same as the accumulated data quantity analysis unit 69, but differs in that the integration unit 80 is provided instead of the period length measurement unit 70. Aside from the comparison/determination unit 506, the configuration is the same as the configuration shown in FIG. 1.

The integration unit 80 determines a time integral D80 of the data quantity D5 in the interval during which the data quantity D5 is continuously greater than the threshold D63 while the door open/close information D4 is ‘1’.

The accumulated data quantity analysis unit 79 performs a comparison to find whether or not the integral D80 obtained by the integration unit 80 exceeds a predetermined threshold (integral threshold) D83; if it is found to exceed the threshold, the accumulated data quantity analysis unit 79 increments the count value in the counting unit 622 by ‘1’.

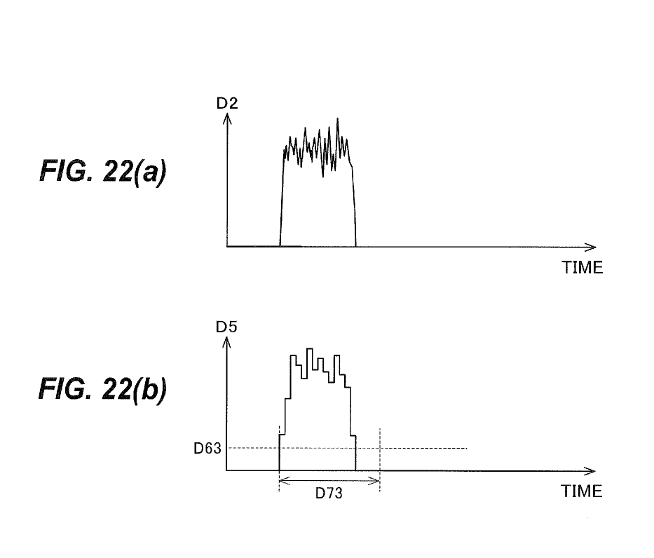

Comparison between FIG. 7(b) and FIG. 19(b) shows that the time integral D80 of the data quantity D5 in the interval during which the data quantity D5 is continuously greater than the threshold D63 is greater in FIG. 19(b). This is because the number of people who have transited is one in FIG. 7(b), but increases to two in FIG. 19(b). If they move past the camera quickly, the time span (the length of the interval during which the data quantity D5 is continuously greater than the threshold D63) is shortened, but their faster movement increases the data quantity. FIGS. 22(a) and 22(b) illustrate how this happens, showing changes in the data quantity when two people move quickly. When the data quantity changes as shown in FIGS. 22(a) and 22(b), the configuration shown in the fifth embodiment cannot increment the count by 1 because the time span (length of the interval during which the data quantity D5 is continuously greater than the threshold D63) is less than the threshold D73, so that detection fails. Conversely, when a single person moves slowly, the changes due to motion are small, so that the data quantity is reduced, but the time span increases, which may cause a false increment of the count. The time span thus changes according to the speed of motion, so that counting people on the basis of the time span causes false detections due to their speed of motion.

In contrast, the integral D80 of the data quantity D5 is less likely to be affected by motion speed. FIGS. 19(a) and 19(b) and FIGS. 22(a) and 22(b) both show changes in the data quantity during a transit by two people; FIGS. 22(a) and 22(b) show that the time span (interval during which the data quantity D5 is continuously greater than the threshold D63) is shorter, but as the data quantity increases, the integral D80 of the data quantity D5 does not change so much.

In the comparison/determination unit 506 in the sixth embodiment, therefore, the integration unit 80 integrates the data quantity D5 over the interval during which the data quantity D5 is continuously greater than the threshold D63, and when the integral D80 exceeds a preset threshold D83, the comparison/determination unit 506 increments the count in the counting unit by 1.

The threshold D83 is preferably set to a value intermediate between, for example, the integrated data quantity value D80 (the integral for a single-person transit) in the interval during which the data quantity D5 is greater than the threshold D63 when a person moves transits the camera's field of view, e.g., when a single person moves from the public area PA into the controlled area CA side and the integrated data quantity value D80 (the integral for a two-person transit) in the interval during which the data quantity D5 is greater than the threshold D63 when two people move into the controlled area CA side with no gap between them.

In this case, the ‘integral for a single-person transit’ and the ‘integral for a two-person transit’ are determined by performing tests. Specifically, the process of measuring the integrated data quantity value D80 when the data quantity D5 is greater than the threshold D63, in a state in which it can be confirmed in another way that a single person is transiting is performed one or more times, and the ‘integral for a single-person transit’ is determined on the basis of the measurement result(s) (e.g., by taking the mean value or median value if multiple measurement results have been obtained).

Similarly, the process of measuring the integrated data quantity value D80 when the data quantity D5 is greater than the threshold D63, in a state in which it can be confirmed in another way that two people are transiting with no gap between them is performed one or more times, and the ‘integral for a two-person transit’ is determined on the basis of the measurement result(s) (e.g., by taking the mean value or median value, if multiple measurement results have been obtained).

When there are individual differences in the ‘integral for a single-person transit’, a threshold D83 may be set for each individual. Specifically, a threshold D83 may be set and stored for each ID read by the card reader 31 of the authentication unit 3.

For example, the threshold D83 may be determined by tests similar to those described above.

Specifically, the ID card of a prospective user is read by the card reader 31, the prospective user is made to move alone (i.e., without occurrence of tailgating), the integral during his/her movement is measured, and the measurement result is stored in association with the read ID. This test measurement is performed one or more times, and on the basis of the measurement result(s), the threshold D83 is determined and stored, for example, in a storage unit 85 (shown in dotted lines in FIG. 21) in association with the ID.

During actual operation, when the ID card of a prospective entrant is read by the card reader 31, whether a threshold D83 associated with the read ID is already stored in the storage unit 85 is determined; if one is already stored, the stored threshold D83 is used to determine the presence or absence of tailgating.

By setting a threshold D83 for each individual in this way, false determination of the presence or absence of tailgating can be reduced even when there are individual differences in transit time.

Instead of determining a threshold D83 for each ID by tests as described above, the threshold D83 may be determined as follows on the basis of the data obtained during actual operation. Specifically, the first time each ID is used for authentication, the integrated data quantity value D80 (the integral of the data quantity in the interval during which the data quantity D5 is continuously greater than the threshold D63) is measured on the assumption of a single-person transit, and the measurement result is stored.

After that, the integrated data quantity value D80 may be stored whenever authentication and transit are performed with the same ID, and a value obtained by multiplying the minimum of two or more stored integrated data quantity values D80 by a coefficient equal to or greater than 1 may be used as the threshold D83. Alternatively, the median value of three or more integrated data quantity values D80 may be set as the threshold D83.

The threshold D83 may be set in this way because tailgating seldom occurs, and the first time each ID is used to transit, the person using the ID can be expected to pay attention to what is going on around him/her and not allow tailgating to take place.

By setting a threshold D83 for each ID as above, it is possible to prevent false detection or failure of detection due to individual differences in the integral of the data quantity in the interval during which the data quantity D5 is continuously greater than the threshold D63.

As described above, according to the sixth embodiment, in order to detect illicit entry (by tailgating) to the controlled area CA, the monitor information processing device 1 images people attempting to enter the controlled area CA with the camera 2, receives the encoded video data D2 from the camera 2, and detects the number of people who have entered the controlled area CA, from changes in the data quantity of the received encoded video data D2. Accordingly, the process of decoding the encoded video data D2 is unnecessary. Consequently, there is no increased cost due to the use of a high-performance CPU to decode the video data D2 or increased number of parts due to the addition of special-purpose LSI circuit chips, and costs can be reduced.

In addition, according to the sixth embodiment, in order to detect illicit entry (by tailgating) to the controlled area CA, the monitor information processing device 1 detects the entry of a person by making a magnitude relation comparison between the accumulated data quantity D5 obtained from accumulation of the data quantities of the video data included in the IP packets over a fixed unit time and a threshold D63. Accordingly, the desired functions can be implemented with a simple software program or digital circuit. Consequently, complex image processing is unnecessary, there is no cost increase due to the use of a high-performance CPU or increased number of parts due to the addition of special-purpose LSI circuit chips, and costs can be reduced.

Also, according to the sixth embodiment, in order to detect illicit entry (by tailgating) to the controlled area CA, the monitor information processing device 1 integrates the accumulated data quantity D5 obtained by accumulating, over a fixed unit time, the data quantities of the video data included in the IP packets, over the interval during which the accumulated data quantity D5 is continuously greater than the threshold D63, and counts people who have entered, on the basis of the result of a magnitude comparison between the integral D80 and the threshold D83. Therefore, illicit entry can be accurately detected even when multiple people transit with no gap between them.

The sixth embodiment also includes an alarm output unit 7 that outputs an alarm when illicit entry is detected, so that those in the surrounding area can be reliably notified of the occurrence of illicit entry.

The sixth embodiment is also configured in such a way that the threshold D63 for the data quantity D5 can be automatically set to an optimal level, so that the entry of people can be detected with high precision.

Also, when a threshold D83 for the integral is set for each individual, even if there are individual differences in the integrated data quantity associated with the movement, a more precise determination of the presence or absence of tailgating can be made.

The sixth embodiment is also configured in such a way that the measurement of the data quantity by the data quantity measurement unit 5 is performed only when the door 9 is in the unlocked state, so that false determinations made by using video data obtained when the door 9 is in the locked state, that is, using video images irrelevant to entry to the controlled area CA, can be prevented, thus enabling the entry of people to be detected with high precision.

The variations described in relation to the first embodiment are also applicable to the second to sixth embodiments. In the second to fourth, fifth, and sixth embodiments, for example, instead of the decision condition that the data quantity of video data has increased across a threshold, the decision condition that the data quantity of the video data has decreased across a threshold may be used.

In the fifth and sixth embodiments, a case in which movement from a public area PA to a controlled area CA is monitored, but the fifth and sixth embodiments may be modified in such a way that movement from the controlled area CA to the public area PA is monitored.

As will be understood from the description of the fourth embodiment, the monitoring device is not limited to inclusion of a single camera; the invention is also applicable when there are two or more cameras. Similarly, the invention is also applicable to monitoring devices in which plural authentication units 3, door control units 4, and audible alarm generators 8 are provided.

Although the invention has been described above as a monitor information processing device, the monitor information processing method implemented by the monitor information processing device also constitutes part of the invention. Some or all of the components of the monitor information processing device in the invention or some or all of the processes in the monitor information processing method in the invention may be implemented by software, that is, by a programmed computer. Therefore, a program that causes a computer to execute the processing performed by the components of the monitor information processing device or the processes in the steps of the monitor information processing method, and a computer-readable storage medium in which this program is stored, also constitute part of the invention.

### REFERENCE CHARACTERS

1, 301: monitor information processing device; 2, 302 camera: 3 authentication unit; 4 door control unit; 5, 305: data quantity measurement unit; 6, 306: comparison/determination unit; 7: alarm output unit; 8: audible alarm generator; 9: door; 51: period measurement unit; 52, 54: packet length calculation unit; 53, 55 data quantity accumulation unit; 61: entry permission counting unit; 62, 65: accumulated data quantity analysis unit; 63, 66: threshold setting unit; 64: illicitness determination unit; 100: monitoring device.

1. A monitor information processing device that detects illicit movement from one of a public area and a controlled area separated by a door to the other, on a basis of
authentication result information indicating permission of movement from one of the public area and the controlled area to the other, generated as a result of a decision as to whether or not to permit the movement, the decision being based on identification information presented by the person attempting the movement,
door open/close information indicating a state of the door, the opening and closing of which are controlled on a basis of the authentication result information, and
encoded video data generated by encoding a video signal obtained by imaging a vicinity of the door,
the monitor information processing device comprising:
a data quantity measurement unit for measuring a data quantity, for each predetermined period, of the encoded video data; and
a comparison/determination unit for detecting the illicit movement on a basis of the door open/close information, the authentication result information, and a length of an interval during which the data quantity for each predetermined period measured by the data quantity measurement unit is continuously greater than a predetermined data quantity threshold.

2. The monitor information processing device of claim 1, wherein the comparison/determination unit counts people moving from the one of the public area and the controlled area to the other, on a basis of a number of times that the length of the interval during which the data quantity for each period is continuously greater than the data quantity threshold has exceeded a predetermined interval length threshold, and detects the illicit movement on a basis of a result of the count, the door open/close information, and the authentication result information.

3. (canceled)

4. A monitor information processing device that detects illicit movement from one of a public area and a controlled area separated by a door to the other, on a basis of
authentication result information indicating permission of movement from one of the public area and the controlled area to the other, generated as a result of a decision as to whether or not to permit the movement, the decision being based on identification information presented by the person attempting the movement,
door open/close information indicating a state of the door, the opening and closing of which are controlled on a basis of the authentication result information, and
encoded video data generated by encoding a video signal obtained by imaging a vicinity of the door,
the monitor information processing device comprising:
a data quantity measurement unit for measuring a data quantity, for each predetermined period, of the encoded video data; and
a comparison/determination unit for detecting the illicit movement on a basis of the door open/close information, the authentication result information, and an integral of the data quantity in an interval during which the data quantity for each predetermined period measured by the data quantity measurement unit is continuously greater than a predetermined data quantity threshold.

5. The monitor information processing device of claim 4, wherein the comparison/determination unit counts of people moving from the one of the public area and the controlled area to the other, on a basis of a number of times that the integral of the data quantity in the interval during which the data quantity for each period is continuously greater than the data quantity threshold has exceeded a predetermined integral threshold, and detects the illicit movement on a basis of a result of the count, the door open/close information, and the authentication result information.

6. (canceled)

7. (canceled)

8. The monitor information processing device of claim 2, wherein the comparison/determination unit automatically adjusts the data quantity threshold on a basis of a maximum value of the data quantity for each period.

9. The monitor information processing device of claim 1, further comprising an alarm output unit for generating an alarm driving signal for generating an audible alarm when the comparison/determination unit determines that the illicit movement has occurred.

10. (canceled)

11. A monitor information processing method that detects illicit movement from one of a public area and a controlled area separated by a door to the other, on a basis of
authentication result information indicating permission of movement from one of the public area and the controlled area to the other, generated as a result of a decision as to whether or not to permit the movement, the decision being based on identification information presented by the person attempting the movement,
door open/close information indicating a state of the door, the opening and closing of which are controlled on a basis of the authentication result information, and
encoded video data generated by encoding a video signal obtained by imaging a vicinity of the door,
the monitor information processing method comprising:
a data quantity measurement step for measuring a data quantity, for each predetermined period, of the encoded video data; and
a comparison/determination step for detecting the illicit movement on a basis of the door open/close information, the authentication result information, and a length of an interval during which the data quantity for each predetermined period measured by the data quantity measurement step is continuously greater than a predetermined data quantity threshold.

12. (canceled)

13. (canceled)

14. A monitor information processing method that detects illicit movement from one of a public area and a controlled area separated by a door to the other, on a basis of
authentication result information indicating permission of movement from one of the public area and the controlled area to the other, generated as a result of a decision as to whether or not to permit the movement, the decision being based on identification information presented by the person attempting the movement,
door open/close information indicating a state of the door, the opening and closing of which are controlled on a basis of the authentication result information, and
encoded video data generated by encoding a video signal obtained by imaging a vicinity of the door,
the monitor information processing method comprising:
a data quantity measurement step for measuring a data quantity, for each predetermined period, of the encoded video data; and
a comparison/determination step for detecting the illicit movement on a basis of the door open/close information, the authentication result information, and an integral of the data quantity in an interval during which the data quantity for each predetermined period measured by the data quantity measurement step is continuously greater than a predetermined data quantity threshold.

15. (canceled)

16. (canceled)

17. (canceled)

18. (canceled)

19. (canceled)

20. (canceled)

21. A program for causing a computer to execute the steps in the monitor information processing method of claim 11.

22. A computer readable recording medium in which the program of claim 21 is recorded.

23. The monitor information processing device of claim 5, wherein the comparison/determination unit automatically adjusts the data quantity threshold on a basis of a maximum value of the data quantity for each period.

24. The monitor information processing device of claim 2, further comprising an alarm output unit for generating an alarm driving signal for generating an audible alarm when the comparison/determination unit determines that the illicit movement has occurred.

25. The monitor information processing device of claim 4, further comprising an alarm output unit for generating an alarm driving signal for generating an audible alarm when the comparison/determination unit determines that the illicit movement has occurred.

26. The monitor information processing device of claim 5, further comprising an alarm output unit for generating an alarm driving signal for generating an audible alarm when the comparison/determination unit determines that the illicit movement has occurred.

27. The monitor information processing device of claim 8, further comprising an alarm output unit for generating an alarm driving signal for generating an audible alarm when the comparison/determination unit determines that the illicit movement has occurred.

28. The monitor information processing device of claim 23, further comprising an alarm output unit for generating an alarm driving signal for generating an audible alarm when the comparison/determination unit determines that the illicit movement has occurred.

29. A program for causing a computer to execute the steps in the monitor information processing method of claim 14.

30. A computer readable recording medium in which the program of claim 29 is recorded.
